(19) United States
(12) Patent Application Publication
(10) Pub. No.: US 2016/0155000 A1
(43) Pub. Date: Jun. 2, 2016

(54) ANTI-COUNTERFEITING FOR DETERMINATION OF AUTHENTICITY

(71) Applicant: BEIJING ZHIGU RUI TUO TECH CO., LTD., Beijing (CN)

(72) Inventor: Lin DU, Beijing (CN)

(21) Appl. No.: 14/906,002

(22) PCT Filed: Jul. 2, 2014
(86) PCT No.: PCT/CN2014/081503

§ 371 Date: Jan. 19, 2016

(30) Foreign Application Priority Data
Nov. 30, 2013 (CN) 201310631779.2
Nov. 30, 2013 (CN) 201310632387.8

(51) Int. Cl. G06K 9/00; G07D 7/12; G07D 7/20

(52) U.S. Cl. CPC G06K 9/00671; G07D 7/2016; G07D 7/128; G06K 9/00604

(57) ABSTRACT

An anti-counterfeiting method and an anti-counterfeiting apparatus are disclosed. The anti-counterfeiting method includes: acquiring an image of an object on which a user gazes; verifying authenticity of the object according to the image to obtain verification prompt information; and projecting the verification prompt information to a fundus of the user according to a location of the object relative to the user. The anti-counterfeiting apparatus includes modules for implementing various steps of the method. In the embodiments of the present application, an image of an object on which a user gazes is acquired automatically, and authenticity of the object is verified, and then verification prompt information is projected to a fundus of the user according to a location of the object relative to the user, which helps the user verify authenticity of the fixation object naturally, conveniently and effectively.

### RELATED APPLICATIONS

This application claims priority to Chinese Patent Application No. 201310632387.8 filed on Nov. 30, 2013 and entitled “ANTI-COUNTERFEITING METHOD AND ANTI-COUNTERFEITING APPARATUS”, and claims priority to Chinese Patent Application No. 201310631779.2, filed on Nov. 30, 2013 and entitled “ANTI-COUNTERFEITING METHOD AND ANTI-COUNTERFEITING APPARATUS”, both of which are herein incorporated by reference in their respective entireties.

### TECHNICAL FIELD

The present application relates to the technical field of anti-counterfeiting, and in particular, to anti-counterfeiting for determination of authenticity.

### BACKGROUND

An anti-counterfeiting technology refers to a measure taken for achieving an anti-counterfeiting objective, which can accurately authenticate authenticity within a certain range and initiation or replication is not easy. Currently, the anti-counterfeiting technology widely applied on the daily life is to set some anti-counterfeiting features on or in an object to be anti-counterfeited, for example, commodity anti-counterfeiting, bill anti-counterfeiting, printing anti-counterfeiting and so on. Sometimes, a user may be not even aware of distinguishing authenticity of the anti-counterfeiting features. In addition, in some occasions, due to the limitation of the conditions or the limitation of the occasions, it may be inconvenient for the user to distinguish the authenticity of an object. Therefore, a natural, convenient and effective anti-counterfeiting method and anti-counterfeiting apparatus are desired.

### SUMMARY

The following presents a simplified summary in order to provide a basic understanding of some example embodiments disclosed herein. This summary is not an extensive overview. It is intended to neither identify key or critical elements nor delineate the scope of the example embodiments disclosed. Its sole purpose is to present some concepts in a simplified form as a prelude to the more detailed description that is presented later.

An example objective of the present application is to provide an anti-counterfeiting technology.

According to a first example embodiment, the present application provides a method, including:

acquiring, by a system comprising a processor, at least one image of an object on which a user gazes;

verifying an authenticity of the object according to the at least one image to obtain verification prompt information; and

initiating projecting the verification prompt information to a fundus of the user according to a location of the object relative to the user.

According to a second example embodiment, the present application provides an apparatus, including:

an image acquisition module, configured to acquire at least one image of an object on which a user gazes;

an authenticity verification module, configured to verify an authenticity of the object according to the at least one image to obtain verification prompt information; and

an information projection module, configured to project the verification prompt information to a fundus of the user according to a location of the object relative to the user.

According to a third example embodiment, the present application provides a wearable device, including the anti-counterfeiting apparatus mentioned above.

In at least one technical solution of the embodiments of the present application, an image of an object on which a user gazes is acquired automatically at a user side and authenticity of the object is verified, and verification prompt information is projected to a fundus of the user by way of corresponding to a location of the object relative to the user, which helps the user obtain verification prompt information about authenticity of the object in a case in which the user has no corresponding verification knowledge or is not aware of verifying authenticity of the object, and the entire verification process is very nature and does not need the user to make any additional verification actions.

### BRIEF DESCRIPTION OF THE DRAWINGS

FIG. 1 is an example step flowchart of an anti-counterfeiting method according to embodiments of the present application;

FIG. 2a is an example flowchart of an authenticity verification step of an anti-counterfeiting method according to the embodiments of the present application;

FIG. 2b is an example flowchart of an authenticity verification step of another anti-counterfeiting method according to the embodiments of the present application;

FIG. 3a to FIG. 3c are example schematic diagrams of verification prompt information and an object viewed by a user in an anti-counterfeiting method according to the embodiments of the present application;

FIG. 4a is an example schematic diagram of a light spot pattern used in an anti-counterfeiting method according to the embodiments of the present application;

FIG. 4b is an example schematic diagram of a fundus pattern obtained in an anti-counterfeiting method according to the embodiments of the present application;

FIG. 5 is an example flowchart of another anti-counterfeiting method according to the embodiments of the present application;

FIG. 6a is an example schematic structural block diagram of an anti-counterfeiting apparatus according to the embodiments of the present application;

FIG. 6b to FIG. 6f are example schematic structural block diagrams of several other anti-counterfeiting apparatuses according to the embodiments of the present application;

FIG. 7a is an example structural block diagram of a location detection module in an anti-counterfeiting apparatus according to the embodiments of the present application;

FIG. 7b is an example structural block diagram of a location detection module in another anti-counterfeiting apparatus according to the embodiments of the present application;

FIG. 7c and FIG. 7d are example schematic diagrams of a corresponding optical path when a location detection module performs location detection according to the embodiments of the present application;

FIG. 8 is an example schematic diagram of an anti-counterfeiting apparatus applied on a pair of spectacles according to the embodiments of the present application;

FIG. 9 is an example schematic diagram of another anti-counterfeiting apparatus applied on a pair of spectacles according to the embodiments of the present application;

FIG. 10 is an example schematic diagram of still another anti-counterfeiting apparatus applied on a pair of spectacles according to the embodiments of the present application;

FIG. 11 is an example structural block diagram of another anti-counterfeiting apparatus according to the embodiments of the present application; and

FIG. 12 is an example schematic diagram of a wearable device according to the embodiments of the present application.

### DETAILED DESCRIPTION

The various methods and apparatuses in the present application are described in detail hereinafter with reference to the accompanying drawings and embodiments.

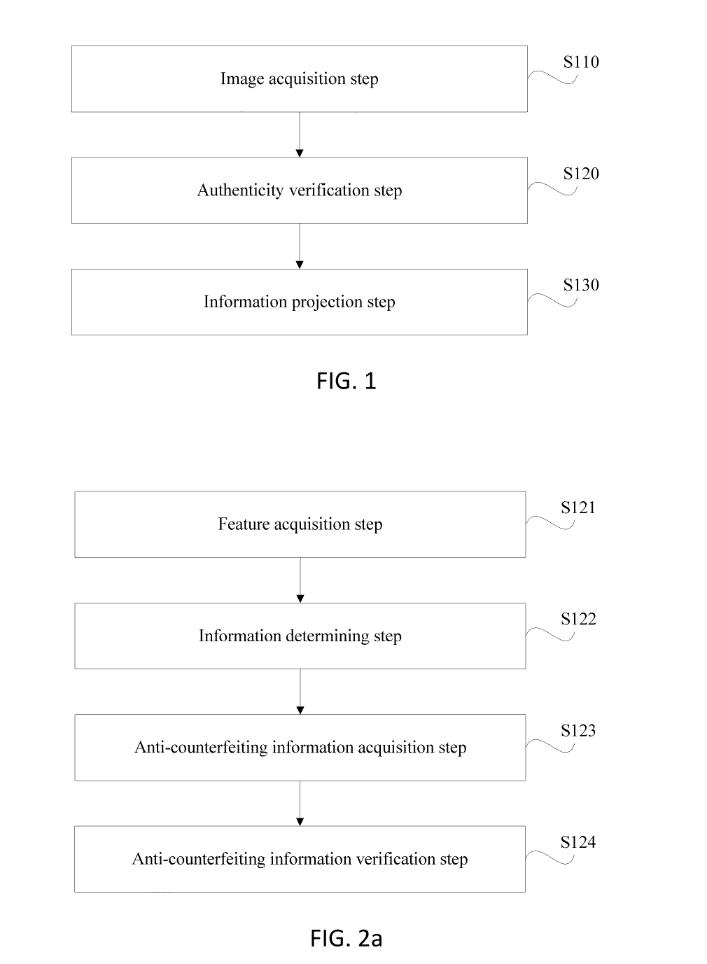

People often encounter occasions in which it is required to verify authenticity of an object in their work and life, for example, when receiving money given by others, when purchasing some products that may be counterfeited, when performing payment and transfer using a webpage and so on, due to some reasons (for example, being incapable of performing verification due to lack of experience, it is inconvenient to perform verification in a current occasion, or being not aware of performing anti-counterfeiting verification), people may suffer losses due to not distinguishing a counterfeited object. Therefore, as shown in FIG. 1, embodiments of the present application provide an anti-counterfeiting method, including:

S110: an image acquisition step of acquiring at least one image of an object on which a user gazes;

S120: an authenticity verification step of verifying authenticity of the object according to the at least one image to obtain verification prompt information; and

S130: an information projection step of projecting the verification prompt information to a fundus of the user according to a location of the object relative to the user.

In the embodiments of the present application, an image of an object on which a user gazes is acquired automatically at a user side and authenticity of the object is verified, and verification prompt information is projected to a fundus of the user, which helps the user obtain verification prompt information about authenticity of the object in a case in which the user has no corresponding verification knowledge or is not aware of verifying authenticity of the object, and the entire verification process is very nature and does not need the user to make any additional verification actions. In addition, the verification prompt information is projected according to a location of the object, so that when the user views the object, an eye of the user can automatically see the verification prompt information clearly without re-focusing, and a more real prompt effect is obtained, thereby improving user experience.

The steps in the method of the embodiments of the present application are further described hereinafter with embodiments:

S110: The image acquisition step of acquiring at least one image of an object on which a user gazes.

In the embodiments of the present application, in step S110, the image of the object on which the user gazes may be acquired via a wearable device of the user, for example, the image of the object on which the user gazes may be captured automatically using a camera on a pair of intelligent spectacles of the user.

In another embodiment, in step S110, the image of the object on which the user gazes may also be obtained by means of interaction. For example, when the user views image information displayed by an electronic device, the electronic device detects gaze of the user and transfers the image information so that the image information is acquired in step S110 in the embodiments of the present application. Certainly, when the object on which the user gazes is an object that does not have an information exchange function, the image may be obtained by means of capturing.

S120: The authenticity verification step of verifying authenticity of the object according to the at least one image to obtain verification prompt information.

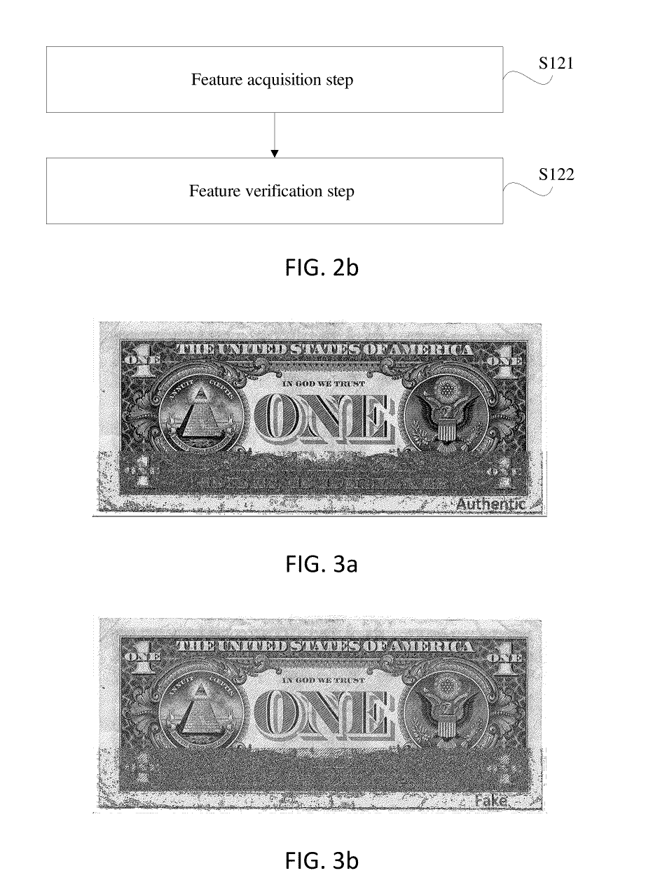

As shown in FIG. 2a, in a possible implementation manner of the embodiments of the present application, step S120 includes:

S121, a feature acquisition step of acquiring, according to the image, a feature to be verified corresponding to a predetermined anti-counterfeiting feature; and

S122, an information determining step of determining whether the feature to be verified contains at least one piece of anti-counterfeiting information to obtain a determined result.

Here, the predetermined anti-counterfeiting feature is an anti-counterfeiting feature that should be included on an authentic object and corresponds to the object on which the user gazes, and may be reserved by way of pre-storing. In the embodiments of the present application, the predetermined anti-counterfeiting feature may be, for example, an anti-counterfeiting label containing predetermined anti-counterfeiting information. The anti-counterfeiting label may be, for example, a digital watermark, a two-dimensional code and so on, and the predetermined anti-counterfeiting information may be obtained therefrom in a specific manner.

Some identification information (namely, a digital watermark) may be directly embedded in a digital carrier by using a digital watermark technology, which does not affect the use of the original carrier and is not easy to be ascertained or modified. Therefore, in the embodiments of the present application, the predetermined anti-counterfeiting feature may be a digital watermark embedded in an object by the provider. Using a case in which the object is image information about a webpage displayed by an electronic device as an example, the predetermined anti-counterfeiting feature is a digital watermark embedded in the image information about the webpage by a provider of the webpage content, where the digital watermark contains predetermined anti-counterfeiting information. Since the digital watermark is hidden in the image and cannot be distinguished by a naked eye, even though a counterfeiter of the webpage completely counterfeits the display content of the webpage, the anti-counterfeiting information contained in the digital watermark still cannot be counterfeited. With the method in the present application, the user can easily distinguish authenticity of a webpage, thereby avoiding losses. Certainly, for other objects, such as books, banknotes and other printed objects, the digital watermark may be embedded in corresponding image information, and then formed by means of printing, print and so on.

When the determined result obtained in step S122 indicates that the feature to be verified contains the anti-counterfeiting information to be verified, step S120 further includes:

S123, an anti-counterfeiting information acquisition step of acquiring the anti-counterfeiting information to be verified from the feature to be verified;

S124, an anti-counterfeiting information verification step of verifying whether the anti-counterfeiting information to be verified satisfies at least one predetermined anti-counterfeiting verification standard to obtain the verification prompt information.

When the determined result obtained in step S122 indicates that the feature to be verified does not contain the anti-counterfeiting information to be verified, the verification prompt information that the object is fake is obtained.

There are multiple methods for acquiring the anti-counterfeiting information in step S123 in the embodiments of the present application, including:

1) Directly extract the anti-counterfeiting information to be verified from the feature to be verified.

2) Send the feature to be verified to the external; and receive the anti-counterfeiting information to be verified returned from the external. That is, an external server or a third-party mechanism extracts the anti-counterfeiting information from the feature to be verified, and only information sending and receiving are performed locally.

There are multiple methods for verifying the anti-counterfeiting information in step S124 in the embodiments of the present application, including:

1) Directly verify locally whether the anti-counterfeiting information to be verified satisfies the predetermined anti-counterfeiting verification standard to obtain the verification prompt information. At this moment, it is required to store the predetermined anti-counterfeiting verification standard into a local storage unit.

2) Send the anti-counterfeiting information to be verified to the external; and receive a result returned from the external regarding whether the anti-counterfeiting information to be verified satisfies the predetermined anti-counterfeiting verification standard. That is, an external server or a third-party mechanism verifies the anti-counterfeiting information to be verified and returns the verification prompt information.

Certainly, in another possible implementation manner of the embodiments of the present application, the steps of extracting and verifying the anti-counterfeiting information in steps S123 and S124 may both be performed at the external, that is, the acquired feature to be verified is directly sent to the external; and the verification prompt information about the feature to be verified returned from the external is received. If extraction and verification are performed at the external, the requirement on the performance of the local device may be lower.

Hereinafter, a case in which the anti-counterfeiting feature is a digital watermark is used as an example.

For example, in a possible implementation manner, two lowest bits of the RGBA (Red Green Blue and Alpha) color space of each pixel of the image may be extracted and combined to obtain the digital watermark (that is, a method of least significant bits (LSB)).

At this moment, the corresponding feature to be verified is a feature to be verified combined correspondingly after the two lowest bits of each pixel of the image of the object to be verified are extracted.

Then, whether the feature to be verified contains anti-counterfeiting information is determined, and if the image does not contain the digital watermark, anti-counterfeiting information cannot be extracted from the extracted feature to be verified, and at this moment, it may be determined that the object is fake; and if the image contains a corresponding digital watermark, corresponding anti-counterfeiting information is extracted using a corresponding watermark extraction method; and then the anti-counterfeiting information to be verified is verified, and if the predetermined anti-counterfeiting verification standard is met, it is determined that the object is authentic, and if not, it is determined that the object is fake and corresponding verification prompt information is obtained.

Certainly, in the embodiments of the present application, the predetermined anti-counterfeiting feature may also be of other forms, and at this moment, the feature to be verified corresponding to the anti-counterfeiting feature is acquired according to the feature of the anti-counterfeiting feature.

In a possible implementation manner, step S120 includes:

verifying whether the at least one image contains at least one predetermined anti-counterfeiting feature to obtain the verification prompt information.

In a possible implementation manner of the embodiments of the present application, the predetermined anti-counterfeiting feature is a special mark provided on the surface of the object for the sake of anti-counterfeiting by a provider of the authentic object. For example, the anti-counterfeiting feature is a specific pattern on the surface of the object (where the specific pattern includes a specific color, a color combination, a specific shape or a combination of color and shape and so on), where the specific pattern may be directly formed on the object, for example, an anti-counterfeiting pattern on the surface of a banknote; or it may be additionally fixed on the object, for example, a radiation label adhered to the surface of the object; the specific pattern may be at a specific location of the object, for example, a specific pattern at a specific location of the surface of a banknote; or it may be located at any location of the surface of the object, for example, the radiation label may be adhered at any location of the surface of the object. In another case, the location of the anti-counterfeiting feature on the object may further change continuously, for example, when the object is a piece of image information displayed by an electronic device, for example, a webpage of an electronic bank, the anti-counterfeiting feature may be embedded in the webpage, but the location thereof may be floating arbitrarily in the window of the webpage.

In step S120 in the method of the embodiments of the present application, the verification prompt information is obtained by verifying whether the image corresponding to the object to be verified contains the predetermined anti-counterfeiting feature. Generally speaking, when the anti-counterfeiting feature is contained, verification prompt information indicating that the object is authentic is obtained, and when the anti-counterfeiting feature is not contained, verification prompt information indicating that the object is fake is obtained. A special implementation manner of the embodiments of the present application is: When the object is authentic, the verification prompt information may not contain prompt information (where at this moment, no additional prompt information is displayed to the fundus of the user), and only when the object is fake, the user is prompted; or in contrary, only when the object is authentic, a prompt is given, and when the object is fake, no prompt is given, that is, when the user does not see corresponding prompt information, accordingly, it may be conceived that the object may be fake.

As shown in FIG. 2b, in a possible implementation manner of the embodiments of the present application, step S120 of verifying authenticity includes:

S121, a feature acquisition step of acquiring, according to the at least one image, at least one feature to be verified corresponding to the at least one predetermined anti-counterfeiting feature; and

S122, a feature verification step of verifying whether the at least one feature to be verified satisfies at least one predetermined verification standard to obtain the verification prompt information.

In a possible implementation manner of the embodiments of the present application, the feature to be verified corresponding to the predetermined anti-counterfeiting feature includes: an image feature corresponding to a location and/or pattern of the predetermined anti-counterfeiting feature. That is, for example:

1) When the predetermined anti-counterfeiting feature is a specific pattern on a specific area of the object:

step S121 includes: acquiring, according to the image, a pattern of an image area corresponding to the specific area as the feature to be verified; and

step S122 includes: verifying whether the acquired pattern satisfies a predetermined verification standard (for example, whether the acquired pattern is consistent with the specific pattern of the predetermined anti-counterfeiting feature; or whether a predetermined verification pattern is obtained after the acquired pattern is combined with a reference image and so on); certainly, one object may have a plurality of areas that contains a plurality of different specific patterns, such as anti-counterfeiting patterns on a plurality of specific locations of a banknote, and at this moment, it may be required to verify the pattern of each area.

2) When the predetermined anti-counterfeiting feature is a specific pattern on a non-specific area of the object:

step S121 includes: acquiring, in the image, an image feature consistent with or closest to the specific pattern; and

step S122 includes: verifying whether the acquired image feature is consistent with the specific pattern; certainly, there may be a plurality of image features, as long as at least one of the plurality of image features contains the specific pattern.

In addition to the embodiments shown in FIG. 2a and FIG. 2b, in another possible implementation manner of the embodiments of the present application, step S120 of verifying authenticity includes:

sending the at least one image to the external; and

receiving the verification prompt information returned from the external.

That is, in this implementation manner, the obtained image of the object to be verified may be sent to a remote server or a third-party mechanism and so on, and authenticity verification is performed on the object according to the image remotely to obtain verification prompt information and then the verification prompt information is returned. In this embodiment, a specific verification process does not need to be performed on the image locally, and therefore, the performance requirements on the local device can be lowered.

S130: an information projection step of projecting the verification prompt information to a fundus of the user according to a location of the object relative to the user.

In the present application, the location of the object relative to the user includes a distance and direction of the object relative to the user.

After the verification prompt information is obtained with steps S110 and S120, it is required to project the verification prompt information to the fundus of the user with step S130, so that the verification prompt information is perceived by the user.

In a possible implementation manner of the embodiments of the present application,

step S130 may include:

projecting the verification prompt information; and

adjusting at least one projection imaging parameter of an optical path between a projection location of the verification prompt information and an eye of the user, until the verification prompt information is imaged to the fundus of the user by way of corresponding to the object and satisfying at least one defined clarity criterion.

In the embodiments of the present application, the defined clarity criterion may be a criterion for determining image clarity for a person skilled in the art, such as resolution.

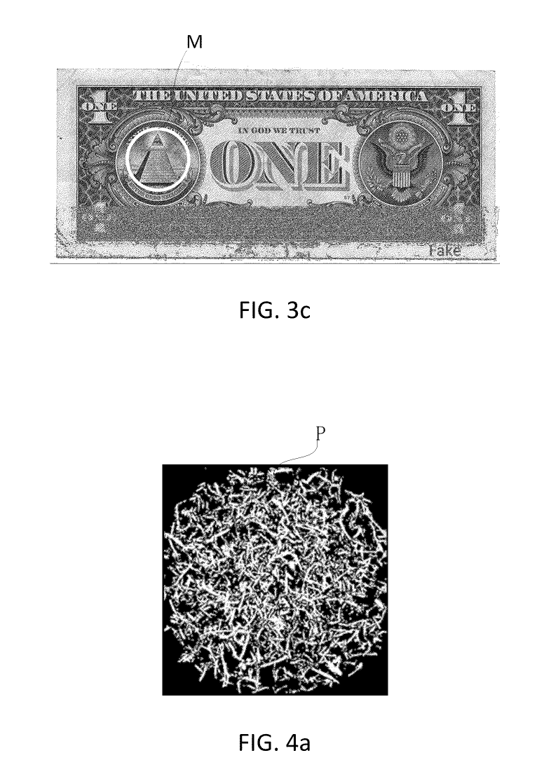

In the embodiments of the present application, that the verification prompt information is imaged to the fundus of the user by way of corresponding to the object may be that the verification prompt information is imaged to the fundus of the user by way of corresponding to the location of the object and/or the content of the object, for example: the verification prompt information is projected according to the location of the object relative to the user, so that the verification prompt information is directly displayed at the location where the object is located. FIG. 3a and FIG. 3b are schematic diagrams of objects on which a user gazes and corresponding verification prompt information (where Authentic represents that an object is authentic, and Fake represents that an object is fake, and in FIG. 3b, the shadow part on the banknote represents that a digital watermark is embedded in this part), so that the user can see the verification prompt information while fixing on the object without adjusting the eye focus. In addition, this fundus projection manner is both natural and secrete, so that the user sees the authenticity verification information about the object while viewing the object, and at the same time, other people do not see the information.

In some cases, for example, when a partial area of the surface of the object is covered or contaminated by stains, verification prompt information that the object is fake is obtained in step S120; however, at this moment, the object may be authentic. Therefore, in the embodiments of the present application, the verification prompt information includes at least one piece of identification information, and the at least one piece of identification information corresponds to at least one image area in the at least one image that does not satisfy at least one verification requirement. In this way, the user may be prompted to obtain a result of judgment by the user according to the verification prompt information with reference to an actual situation, thereby reducing the possibility of misjudgment.

In order to identify the at least one piece of identification information on the object on which the user gazes, in this implementation manner, the at least one piece of identification information is projected to the fundus of the user by way of corresponding to the location on the object corresponding to the at least one image area. As shown in FIG. 3c, it is found during the verification process of the object that, the image area of the pyramid part on the image of the banknote in FIG. 3c does not satisfy the verification requirement, in addition to a displayed Fake identification representing that the object is fake, the verification prompt information includes a piece of round identification information M, and the identification information M and the pyramid part on the banknote are projected to the fundus of the user correspondingly, so that the user can see the identification information while viewing the object, and therefore can see through the verification of which place goes wrong.

In a possible implementation manner of the embodiments of the present application, the parameter adjustment step includes:

adjusting at least one imaging parameter of at least one optical element of the optical path between the projection location and the eye of the user and/or a location thereof in the optical path.

Here, the imaging parameter includes a focal length, an optical axis direction and so on of the optical element. By way of adjustment, the verification prompt information can be properly projected to the fundus of the user, for example, by adjusting the focal length of the optical element, the verification prompt information is imaged on the fundus of the user clearly. Alternatively, in the following implementation manner, when three-dimensional display is required, in addition to directly generating left and right eye images with visual differences when generating the verification prompt information, by projecting the same verification prompt information to two eyes respectively with a certain deviation, a three-dimensional display effect of the verification prompt information can also be achieved. At this moment, for example, the effect can be achieved by adjusting the optical axis parameter of the optical element.

Since the sight line direction of the eye may be different when the user views an object, it is required to project the verification prompt information to the fundus of the user when the sight line of the eye of the user is different, and therefore, in a possible implementation manner of the embodiments of the present application, the information projection step S130 further includes:

transferring the verification prompt information to the fundus of the user by way of respectively corresponding to locations of a pupil when the optical axis direction of the eye is different.

In a possible implementation manner of the embodiments of the present application, it may be required to implement the function of the step with a curved optical element such as a curved beam splitter. However, after being transferred with a curved optical element, the content to be displayed may be deformed, and therefore, in a possible implementation manner of the embodiments of the present application, the information projection step S130 further includes: performing, on the verification prompt information, reverse deforming processing corresponding to the location of the pupil when the optical axis direction of the eye is different, so that the fundus receives the verification prompt information to be presented.

For example, pre-processing is performed on the verification prompt information to be projected, so that the projected verification prompt information has reverse deforming opposite to the deforming, and this reverse deforming effect and the deforming effect of the curved optical element are offset after passing through the curved optical element. Therefore, the verification prompt information received by the fundus of the user is the effect to be presented to the user.

Therefore, in a possible implementation manner of the embodiments of the present application, the information projection step S130 includes:

an alignment adjustment step of aligning the verification prompt information with the image of the object on which the user gazes and then projecting the verification prompt information to the fundus of the user.

In order to implement the alignment function, in a possible implementation manner, the method further includes:

a location detection step of detecting a location of a gaze point of the user relative to the user; and

in the information projection step S130, the projected verification prompt information is aligned, according to the location of the gaze point of the user relative to the user, with the image viewed by the user at the fundus of the user. Here, “align” refers to that the verification prompt information corresponds to the object viewed by the user in terms of both distance and direction, that is, it may be deemed that the verification prompt information is superposed on the object.

Here, since the user is fixing on the object at this moment, for example, a banknote or image information displayed by an electronic device (where at this moment, the predetermined anti-counterfeiting feature may be, for example, a digital watermark embedded in image information of a webpage by a provider of webpage content, and the digital watermark contains predetermined anti-counterfeiting information), the location corresponding to the gaze point of the user is the location of the object.

In this implementation manner, there are multiple methods for detecting the location of the gaze point of the user, for example, including one or more of the following:

i) Employ a pupil direction detector to detect an optical axis direction of one eye, and then obtain the depth of a gaze scenario of the eye by using a depth sensor (such as infrared ranging) to obtain the location of the gaze point of the sight line of the eye. This technology belongs to the prior art, which is not described in this implementation manner.

ii) Respectively detect optical directions of two eyes, and then obtain sight line directions of the two eyes of the user according to the optical axis directions of the two eyes, and obtain the location of the gaze point of the sight lines of the eyes according to the intersection point of the sight line directions of the two eyes. This technology also belongs to the prior art, which is not described here.

iii) Obtain the location of the gaze point of the sight line of the eye according to an optical parameter of an optical path between a collection location of the image and the eye and an optical parameter of the eye that are obtained when a clearest image presented on the imaging surface of the eye is collected. In the embodiments of the present application, the detailed process of this method is provided in the following, which is not described here.

Certainly, a person skilled in the art can know that in addition to the several forms of gaze point detection methods, other methods for detecting a gaze point of an eye of a user may also be used in the method of the embodiments of the present application.

The step of detecting the location of the current gaze point of the user by using the method iii) includes:

a fundus image collection step of collecting an image of the fundus of the user;

an adjustable imaging step of adjusting at least one imaging parameter of an optical path between a collection location of the fundus image and the eye of the user until the clearest image is collected; and

an image processing step of analyzing the collected fundus image to obtain the imaging parameter, corresponding to the clearest image, of the optical path between the collection location of the fundus image and the eye and at least one optical parameter of the eye, and calculating the location of the current gaze point of the user relative to the user.

By analyzing the image of the eye fundus, the optical parameter of the eye when the clearest image is collected is obtained, so that a current focus location of the sight line is calculated, which provides a basis for further detecting the observation behavior of the observer based on the precise focusing point location.

Here, the image presented by the “fundus” is mainly an image presented on the retina, which may be an image of the fundus itself or an image of another object projected to the fundus, such as a light spot pattern mentioned below.

In the adjustable imaging step, by adjusting a focal length of an optical element on the optical path between the eye and the collection location and/or the location thereof in the optical path, and the clearest image of the fundus can be obtained when the optical element is located at a certain location or in a certain state. The adjustment may be performed continuously and in real time.

In a possible implementation manner of the embodiments of the present application, the optical element may be a focal-length adjustable lens, used for adjusting the focal length by adjusting its refraction index and/or shape. Specifically: 1) the focal length is adjusted by adjusting a curvature of at least one surface of the focal-length adjustable lens, for example, adjusting the curvature of the focal-length adjustable lens by increasing or reducing the liquid medium in a cavity formed by two transparent layers; and 2) the focal length is adjusted by changing the refraction index of the focal-length adjustable lens, for example, a specific liquid crystal medium is filled in the focal-length adjustable lens, and an arrangement manner of the liquid crystal medium is adjusted by adjusting a voltage of a corresponding electrode of the liquid crystal medium, thereby changing the refraction index of the focal-length adjustable lens.

In another possible implementation manner of the embodiments of the present application, the optical element may be: a lens set for adjusting the focal length of the lens set by adjusting a relative location between lenses in the lens set. Alternatively, one or more lenses in the lens set are the focal-length adjustable lens.

In addition to the two methods of changing the system optical path parameter by using the characteristics of the optical element itself, the system optical path parameter may also be changed by adjusting the location of the optical element on the optical path.

In addition, in the method of the embodiments of the present application, the image processing step further includes:

analyzing the image collected in the fundus image collection step to find a clearest image; and

calculating an optical parameter of the eye according to the clearest image and the imaging parameter that is known when the clearest image is obtained.

By the adjustment in the adjustable imaging step, the clearest image can be collected. However, it is required to find the clearest image with the image processing step. The optical parameter of the eye can be obtained by calculation according to the clearest image and the known optical path parameter.

In the method of the embodiments of the present application, the image processing step may further include:

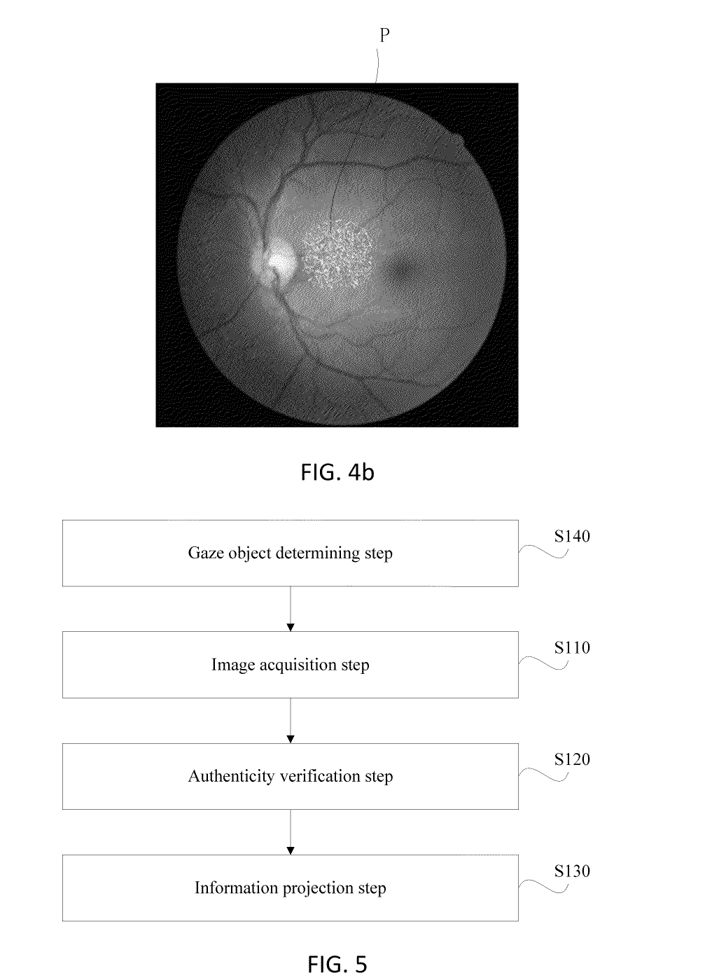

projecting a light spot to the fundus. The projected light spot may have no specific pattern and be merely used for illuminating the fundus. The projected light spot may also include a pattern with rich features. The pattern rich in features can facilitate detection and improve the detection precision. FIG. 4a is a schematic diagram of a light spot pattern P, where the pattern may be generated by a light spot generator, such as a frosted glass. FIG. 4b shows a fundus image collected when the light spot pattern P is projected.

In order not to affect the normal viewing of the eye, the light spot may be an infrared light spot invisible to the eye. At this moment, in order to reduce the interference from other spectrums, the light except the light invisible to the eye in the projected light spot may be filtered.

Correspondingly, the method in the present application may further include the following step:

controlling brightness of the projected light spot according to a result obtained by analysis in the foregoing step. The analysis result includes, for example, the characteristics of the collected image, the contrast of image features, texture features and so on.

It should be noted that a special case for controlling the brightness of the projected light spot is to start or stop projection, for example, projection may be stopped periodically when the observer continuously gazes on a point; and projection may be stopped when the fundus of the observer is bright enough, and the distance from the current sight line focusing point of the eye to the eye is detected using fundus information.

In addition, the brightness of the light spot may also be controlled according to ambient light.

In the method of the embodiments of the present application, the image processing step further includes:

calibrating the fundus image to obtain at least one reference image corresponding to the image presented on the fundus. Specifically, the collected image is compared with the reference image to obtain the clearest image. Here, the clearest image may be an obtained image with the smallest difference from the reference image. In the method of this implementation manner, the difference between the currently obtained image and the reference image may be calculated using an existing image processing algorithm, such as using a classic phase difference automatic focusing algorithm.

The optical parameter of the eye may include the optical axis direction of the eye obtained according to the feature of the eye when the clearest image is collected. Here, the feature of the eye may be acquired from the clearest image or acquired elsewhere. The gaze direction of the sight line of the eye of the user may be obtained according to the optical axis direction of the eye. Specifically, the optical axis direction of the eye may be obtained according to the feature of the fundus when the clearest image is obtained, and the precision is higher when the optical axis direction of the feature is determined using the feature of the fundus.

When projecting a light spot pattern to the fundus, the size of the light spot pattern may be greater than a fundus visible area or smaller than the fundus visible area.

When the area of the light spot pattern is less than or equal to the fundus visible area, the optical axis direction of the eye may be determined by detecting the location of the light spot pattern on the image relative to the fundus and using a classic feature point matching algorithm (such as Scale Invariant Feature Transform (SIFT)).

When the area of the light spot pattern is greater than the fundus visible area, the optical axis direction of the eye and the sight line direction of the observer may be determined using the location of the obtained light spot pattern on the image relative to the original light spot pattern (obtained by image calibration).

In another possible implementation manner of the embodiments of the present application, the optical axis direction of the eye may also be obtained according to the feature of the eye pupil when the clearest image is obtained. Here, the feature of the eye pupil may be acquired from the clearest image or acquired elsewhere. Obtaining the optical axis direction of the eye through the eye pupil feature belongs to the prior art, which is not described here.

In addition, in the method of the embodiments of the present application, a step of calibrating the optical axis direction of the eye may further be included, so as to determine the optical axis direction of the eye more precisely.

In the method of the embodiments of the present application, the known imaging parameter includes a fixed imaging parameter and a real-time imaging parameter, where the real-time imaging parameter is parameter information about the optical element when the clearest image is acquired, and the parameter information may be obtained by recording in real time when the clearest image is acquired.

After the current optical parameter of the eye is obtained, the location of the gaze point of the eye can be obtained in combination with the calculated distance from the eye focusing point to the eye (where the specific process is described in detail in the apparatus part).

In order to enable the verification prompt information viewed by the user to have a three-dimensional display effect and to be more authentic, in a possible implementation manner of the embodiments of the present application, the verification prompt information may be projected to the fundus of the user in a three-dimensional manner in the information projection step S130.

As described above, in a possible implementation manner, the three-dimensional display may be projecting the same information by adjusting the projection location in the information projection step S130, so that the two eyes of the user view the information with a visual difference and the three-dimensional display effect is formed.

In another possible implementation manner, the verification prompt information includes three-dimensional information respectively corresponding to the two eyes of the user, and in the information projection step S130, corresponding verification prompt information is projected to the two eyes of the user respectively. That is, the verification prompt information includes left-eye information corresponding to the left eye of the user and right-eye information corresponding to the right eye of the user, and during projection, the left-eye information is projected to the left eye of the user, and the right-eye information is projected to the right eye of the user, so that the verification prompt information viewed by the user has a proper three-dimensional display effect, bringing better user experience.

In some embodiments, the image acquired by the user in the image acquisition step may be the images of all the objects appearing in the field of view of the user, and in the embodiments of the present application, the verification process may be performed on one or some main objects to be anti-counterfeited in the field of view. In another embodiment, an object on which the user gazes may be determined first, and then the verification process is performed on the object, avoiding verification on other unnecessary objects. Therefore, as shown in FIG. 5, in the embodiments of the present application, before the authenticity verification step, the method further includes:

a gaze object determining step S140 of determining an object on which a user gazes.

In the embodiments of the present application, the method further includes:

a location detection step of detecting a location of a gaze point of the user relative to the user; and

the gaze object determining step S140 is determining, according to the location of the gaze point relative to the user, the object on which the user gazes.

In this embodiment, the location detection step here is the same as the location detection step in the information projection step, and may even be the same, which is not described here.

A person skilled in the art may understand that in the method of the specific implementation manners of the present application, the sequential numbers of the steps do not mean an execution order, and the execution order of the steps is determined according to the functions and internal logic thereof and does not set any limitation to the implementation processes of the specific implementation manners of the present application.

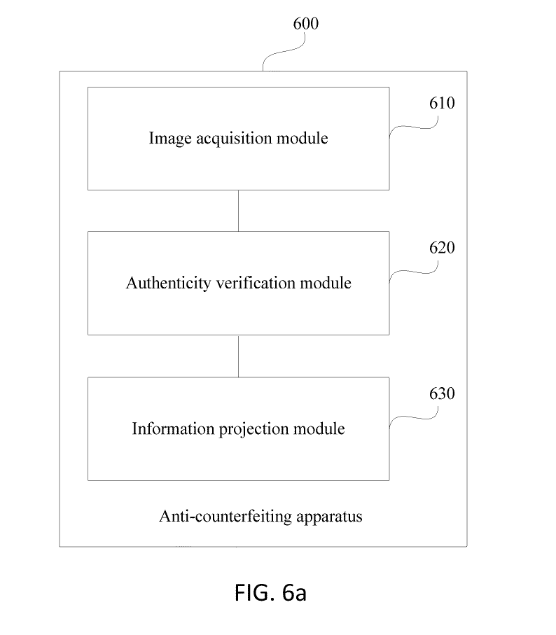

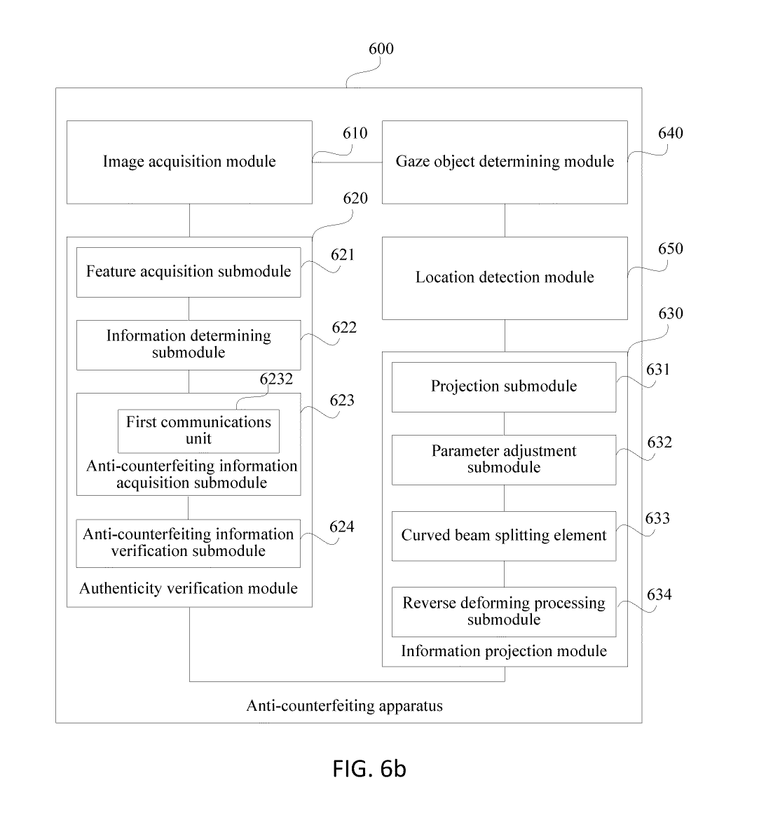

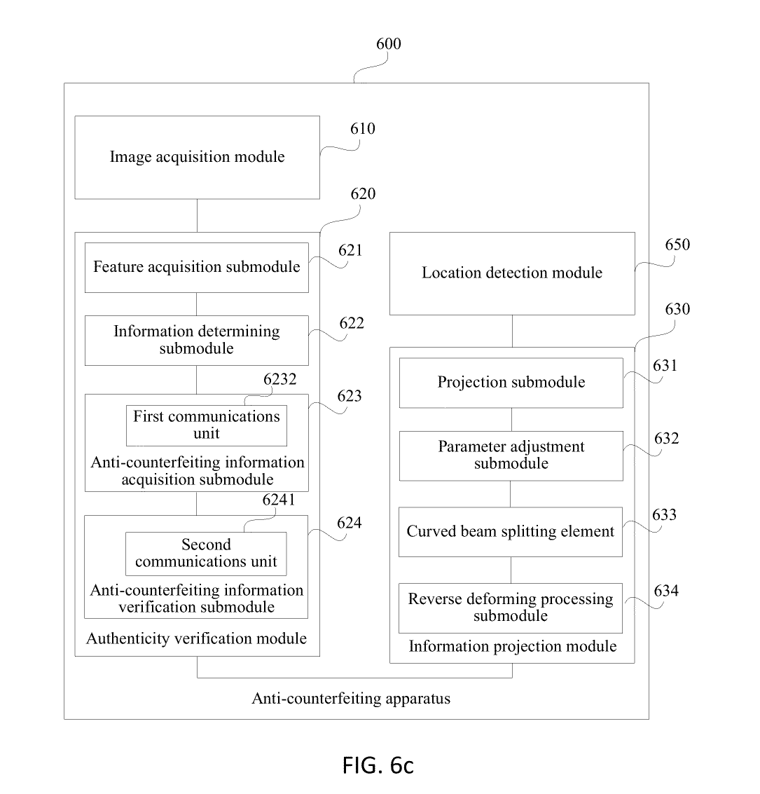

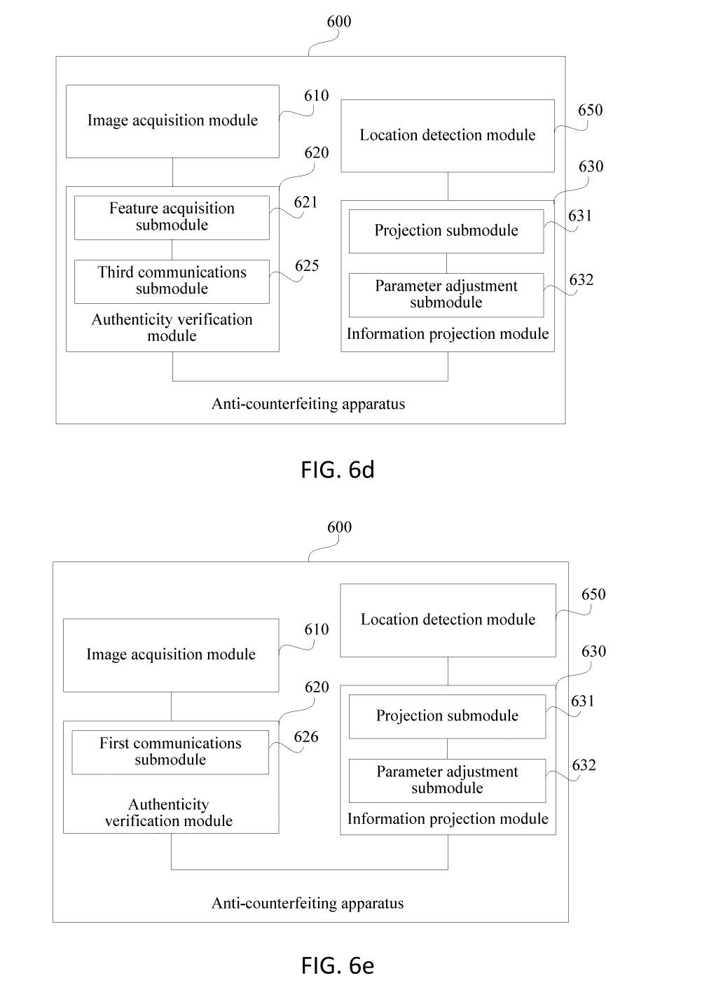

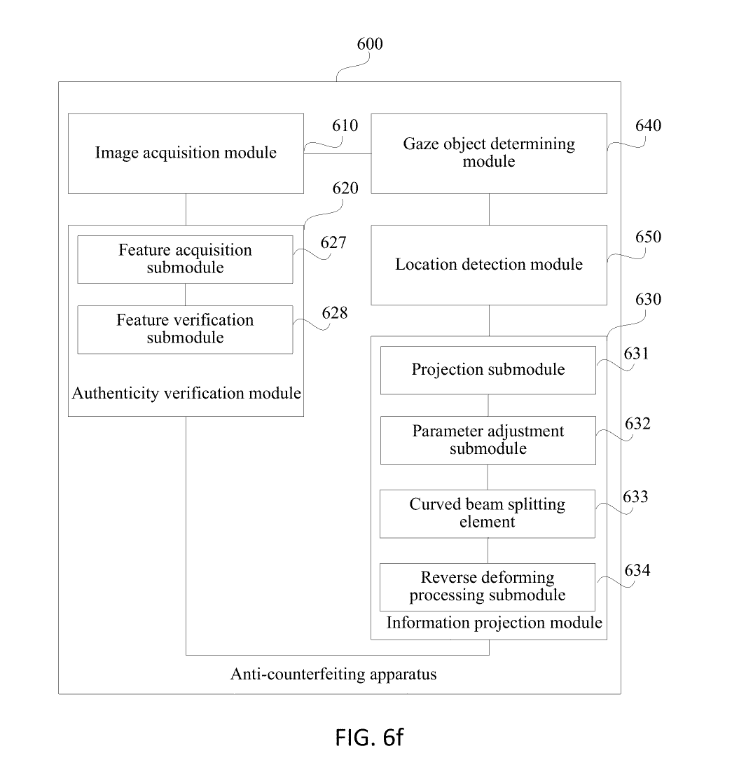

As shown in FIG. 6a, the embodiments of the present application further provide an anti-counterfeiting apparatus 600, including:

an image acquisition module 610, used for acquiring an image of an object on which a user gazes;

an authenticity verification module 620, used for verifying authenticity of the object according to the at least one image to obtain verification prompt information; and

an information projection module 630, used for projecting the verification prompt information to a fundus of the user according to a location of the object relative to the user.

The anti-counterfeiting apparatus in the embodiments of the present application automatically acquires an image of an object on which a user gazes and verifies authenticity of the object, and projects verification prompt information to a fundus of the user, which helps the user obtain verification prompt information about authenticity of the object in a case in which the user has no corresponding verification knowledge or is not aware of verifying authenticity of the object, and the entire verification process is very nature and does not need the user to make any additional verification actions. In addition, the verification prompt information is projected according to a location of the object, so that when the user views the object, an eye of the user can automatically see the verification prompt information clearly without re-focusing, and a more real prompt effect is obtained, thereby improving user experience.

Various modules in the apparatus of the embodiments of the present application are further described hereinafter with embodiments:

In the embodiments of the present application, the image acquisition module 610 may be an image collection module, for example, may be an image collection module on a wearable device near the head of the user, for example, a camera of a pair of intelligent spectacles worn by the user. The image of the object is obtained by the image collection module by performing image collection on the object on which the user gazes.

Certainly, in another embodiment, the image acquisition module 610 may also be, for example, an interaction module between devices, for example, when the object is image information displayed by an electronic device, when it is detected that the user is fixing on the object (where the detection may be performed by the electronic device or the apparatus of the embodiments of the present application), the image of the object may be acquired by information exchange between the electronic device and the image acquisition module 610.

As shown in FIG. 6b, in the embodiments of the present application, the authenticity verification module 620 includes:

a feature acquisition submodule 621, used for acquiring, according to the at least one image, at least one feature to be verified corresponding to the at least one predetermined anti-counterfeiting feature;

an information determining submodule 622, used for determining whether the at least one feature to be verified contains at least one piece of anti-counterfeiting information to be verified to obtain a determined result;

an anti-counterfeiting information acquisition submodule 623, used for acquiring the anti-counterfeiting information to be verified in a case in which the at least one feature to be verified contains the at least one piece of anti-counterfeiting information to be verified; and

an anti-counterfeiting information verification submodule 624, used for verifying whether the acquired at least one piece of anti-counterfeiting information to be verified satisfies at least one predetermined anti-counterfeiting verification standard to obtain the verification prompt information.

The information determining submodule 623 is further used for obtaining verification prompt information that the object is fake when the at least one feature to be verified does not contain the at least one piece of anti-counterfeiting information to be verified. Certainly, in another embodiment, only when the object is authentic, verification prompt information may be generated to prompt the user that the object is authentic, and when the object is fake, verification prompt information is not generated. At this moment, when the at least one feature to be verified does not contain the at least one piece of anti-counterfeiting information to be verified, the information determining submodule may not take any action.

In this implementation manner, the at least one predetermined anti-counterfeiting feature is an anti-counterfeiting feature that should be included on an authentic object and corresponds to the object on which the user gazes, and the anti-counterfeiting feature may be pre-stored in a storage module of the apparatus. In the embodiments of the present application, the predetermined anti-counterfeiting feature may be, for example, an anti-counterfeiting label containing predetermined anti-counterfeiting information. The anti-counterfeiting label may be, for example, a digital watermark, a two-dimensional code and so on, and the predetermined anti-counterfeiting information may be obtained therefrom in a specific manner.

Some identification information (such as, a digital watermark) may be directly embedded in a digital carrier by using a digital watermark technology, which does not affect the use of the original carrier and is not easy to be ascertained or modified. Therefore, in the embodiments of the present application, the predetermined anti-counterfeiting feature may be a digital watermark embedded in an object by the provider. Using a case in which the object is image information about a webpage displayed by an electronic device as an example, the predetermined anti-counterfeiting feature is a digital watermark embedded in the image information about the webpage by a provider of the webpage content, where the digital watermark contains predetermined anti-counterfeiting information. Since the digital watermark is hidden in the image and cannot be distinguished by a naked eye, even though a counterfeiter of the webpage completely counterfeits the display content of the webpage, the anti-counterfeiting information contained in the digital watermark still cannot be counterfeited. With the method in the present application, the user can easily distinguish authenticity of a webpage, thereby avoiding losses.

When the anti-counterfeiting feature is the digital watermark, the feature acquisition submodule 621 analyzes, by using a public or private watermark extraction method, the content in the image to obtain the digital watermark.

As shown in FIG. 6b, in the embodiments of the present application, the anti-counterfeiting information acquisition submodule 623 includes:

an information extraction module 6231, used for extracting the at least one piece of anti-counterfeiting information to be verified from the at least one feature to be verified.

Using a case in which the predetermined anti-counterfeiting feature is a digital watermark as an example, at this moment, the information extraction unit 6231 first acquires a public key of a provider of an authentic object to be verified, and then extracts, with the public key and a public or private algorithm, the anti-counterfeiting information in the feature to be verified.

As shown in FIG. 6c, in another embodiment of the present application, the anti-counterfeiting information to be verified in the feature to be verified may be acquired by means of network service, and at this moment, the anti-counterfeiting information acquisition submodule 623 includes:

a first communications unit 6232, used for:

sending the at least one feature to be verified to the external; and

receiving the at least one piece of anti-counterfeiting information to be verified returned from the external.

Specifically, the feature to be verified is sent to an external server or a third-party mechanism by using the first communications unit 6232, and the anti-counterfeiting information is returned after the anti-counterfeiting information is extracted from the feature to be verified by the external server or the third-party mechanism. In this embodiment, the anti-counterfeiting apparatus of the embodiments of the present application only sends and receives information in the process of acquiring the anti-counterfeiting information to be verified.

There may be multiple methods for verifying anti-counterfeiting information by the anti-counterfeiting information verification submodule 624 in the embodiments of the present application, including:

1) The anti-counterfeiting information verification submodule 624 directly verifies locally whether the anti-counterfeiting information to be verified satisfies at least one predetermined anti-counterfeiting verification standard to obtain the verification prompt information. At this moment, it is required to store the predetermined anti-counterfeiting verification standard in a local storage unit.

2) As shown in FIG. 6c, in another embodiment of the present application, the anti-counterfeiting information verification submodule 624 includes: a second communications unit 6241, used for:

sending the anti-counterfeiting information to be verified to the external; and

receiving a result returned from the external regarding whether the anti-counterfeiting information to be verified satisfies the predetermined anti-counterfeiting verification standard. That is, an external server or a third-party mechanism verifies the anti-counterfeiting information to be verified and returns the verification prompt information.

In the embodiments of the present application, it may be as follows: The information extraction unit 6231 extracts locally the anti-counterfeiting information to be verified and then the anti-counterfeiting information verification submodule 624 (or the second communications unit 6241) verifies locally or externally the anti-counterfeiting information to be verified; or the first communications unit 6232 acquires the anti-counterfeiting information to be verified extracted externally and then the anti-counterfeiting information verification submodule 624 (or the second communications unit 6241) verifies locally or externally the anti-counterfeiting information to be verified.

In the embodiments of the present application, the first communications unit 6232 and the second communications unit 6241 may be separate communications modules, and some or all functions thereof may also be implemented by the same communications module.

In another possible implementation manner, as shown in FIG. 6d, the authenticity verification module 620 includes:

a feature acquisition submodule 621, used for acquiring, according to the at least one image, at least one feature to be verified corresponding to the at least one predetermined anti-counterfeiting feature; and

a third communications submodule 625, used for

sending the at least one feature to be verified to the external; and

receiving the verification prompt information returned from the external.

That is, the anti-counterfeiting information may be extracted and verified externally.

In another possible implementation manner, as shown in FIG. 6e, the authenticity verification module 620 includes:

a first communications submodule 626, used for

sending the at least one image to the external; and

receiving the verification prompt information returned from the external.

That is, in this embodiment, the first communications submodule 626 sends the obtained image of the object to be verified to a remote server or a third-party mechanism and so on, and authenticity verification is performed on the object according to the image remotely to obtain verification prompt information and then the verification prompt information is returned. In this embodiment, a specific verification process does not need to be performed on the image locally, and therefore, the performance requirements on the local device can be lowered.

As shown in FIG. 6f, in another possible implementation manner, the authenticity verification module 620 obtains verification prompt information by verifying whether the image corresponding to the object to be verified contains a predetermined anti-counterfeiting feature. In this implementation manner, for definition of the predetermined anti-counterfeiting feature, reference may be made to the corresponding description in the method embodiment shown in FIG. 2b, which is not described here.

Generally speaking, when the predetermined anti-counterfeiting feature is contained in the image, verification prompt information indicating that the object is authentic is obtained, and when the anti-counterfeiting feature is not contained, verification prompt information indicating that the object is fake is obtained.

In this implementation manner, the authenticity verification module 620 may include:

a feature acquisition submodule 627, used for acquiring, according to the image, a feature to be verified corresponding to the predetermined anti-counterfeiting feature; and

a feature verification submodule 628, used for verifying whether the feature to be verified satisfies at least one predetermined verification standard to obtain the verification prompt information.

In the embodiments of the present application, the feature acquisition submodule 627 is further used for acquiring, according to the image, an image feature corresponding to a location and/or pattern of the predetermined anti-counterfeiting feature as the feature to be verified.

For the processes in which the feature acquisition submodule 627 and the feature verification submodule 628 acquire and verify the feature to be verified in the image, reference may be made to the description of corresponding steps in the method embodiment shown in FIG. 2b, which are not described here.

In this embodiment, the information projection module 630 is used for projecting the verification prompt information to a fundus of the user according to a location of the object relative to the user. Here, the “projecting the verification prompt information to a fundus of the user according to a location of the object relative to the user” refers to that the verification prompt information seen by the user corresponds to the object in terms of distance and direction, that is, it may be deemed that the verification prompt information is superposed on the object. Acquiring the location of the object relative to the user is described in detail hereinafter.

As shown in FIG. 6b, in the embodiments of the present application, the information projection module 630 includes:

a projection submodule 631, used for projecting the verification prompt information; and

a parameter adjustment submodule 632, used for adjusting at least one projection imaging parameter of an optical path between a projection location and the eye of the user, until the verification prompt information is imaged to the fundus of the user clearly by way of corresponding to the image of the object.

In some cases, for example, when a partial area of the surface of the object is covered or contaminated by stains, the authenticity verification module 620 obtains verification prompt information that the object is fake; however, at this moment, the object may be authentic. Therefore, in a possible implementation manner:

the verification prompt information includes at least one piece of identification information, and the at least one piece of identification information corresponds to at least one image area in the at least one image that does not satisfy at least one verification requirement.

At this moment, the information projection module 630 is further used for projecting the at least one piece of identification information to the fundus of the user by way of corresponding to a location which corresponds to the at least one image area on the object (where the image projected to the image is shown in FIG. 3c).

In this way, the user may be prompted to obtain a result of judgment by the user according to the verification prompt information with reference to an actual situation, thereby reducing the possibility of misjudgment.

In the present application, the location of the object relative to the user includes the distance and direction of the object relative to the user.

As shown in FIG. 6b, in an implementation manner, the information projection module 630 includes:

a curved beam splitting element 633, used for transferring the verification prompt information to the fundus of the user by way of respectively corresponding to locations of a pupil when the optical axis direction of the eye is different.

In an implementation manner, the information projection module 630 includes:

a reverse deforming processing submodule 634, used for performing, on the verification prompt information, reverse deforming processing corresponding to the location of the pupil when the optical axis direction of the eye is different, so that the fundus receives the verification prompt information to be presented.

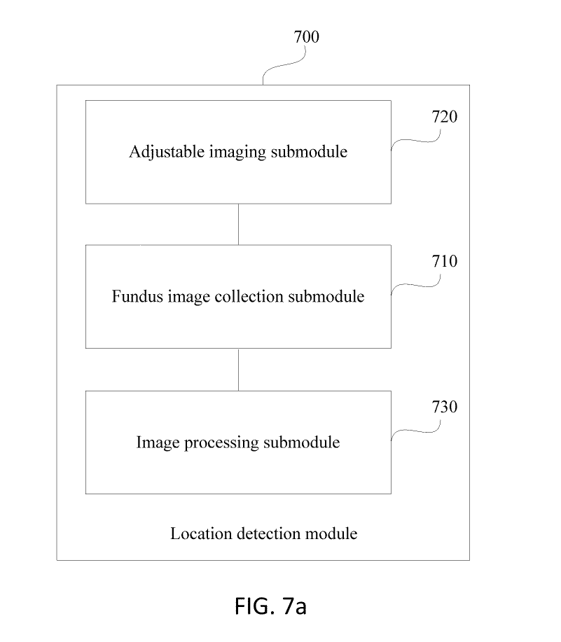

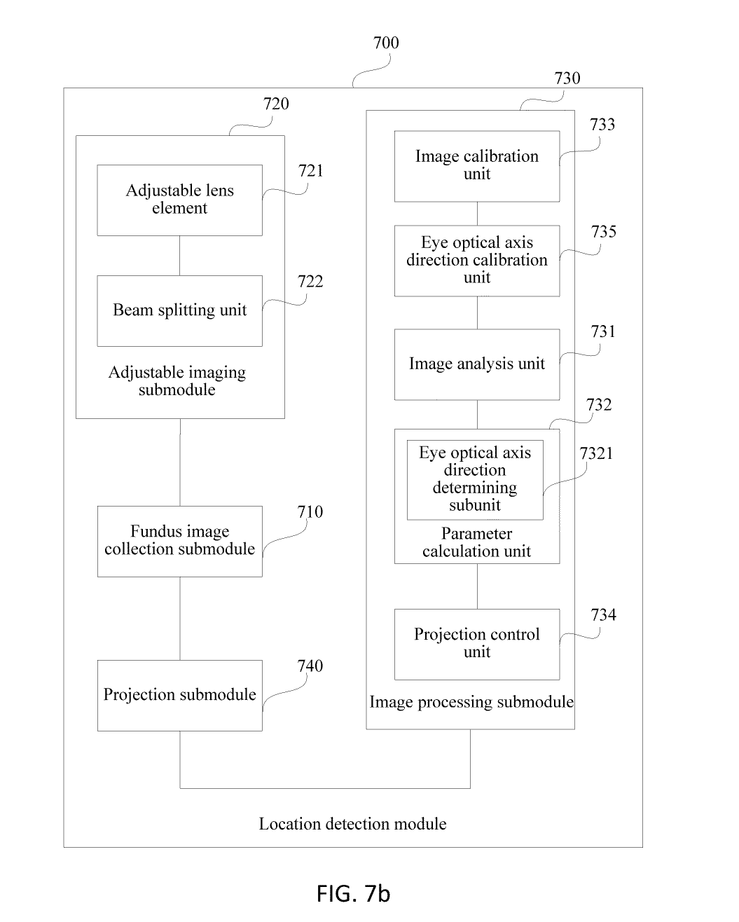

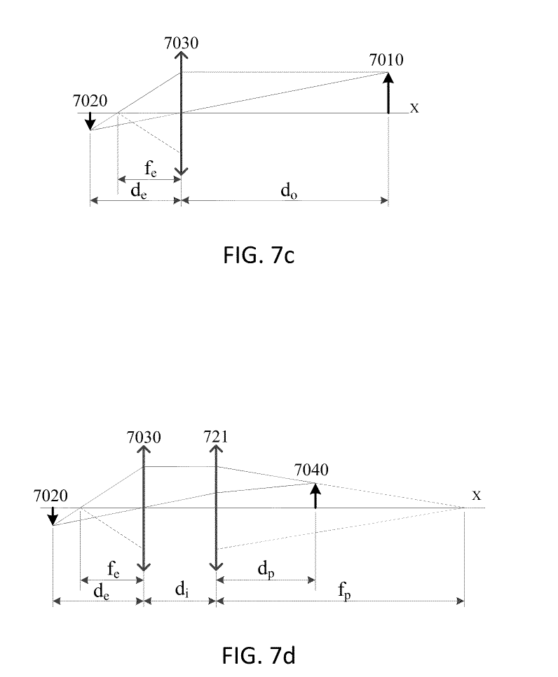

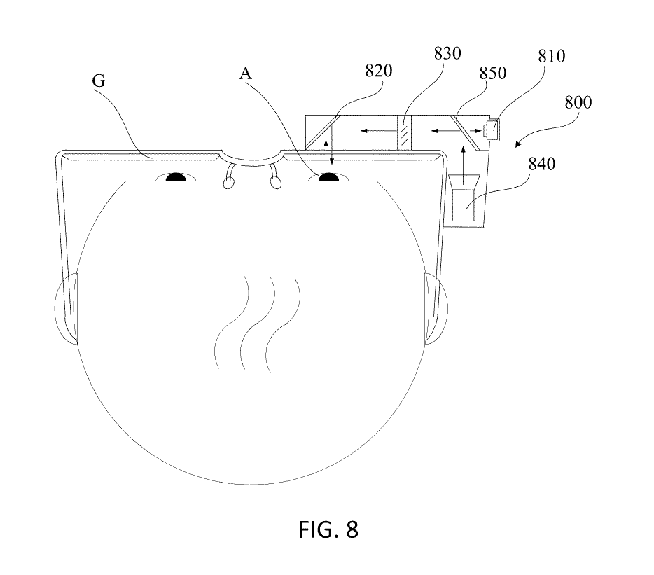

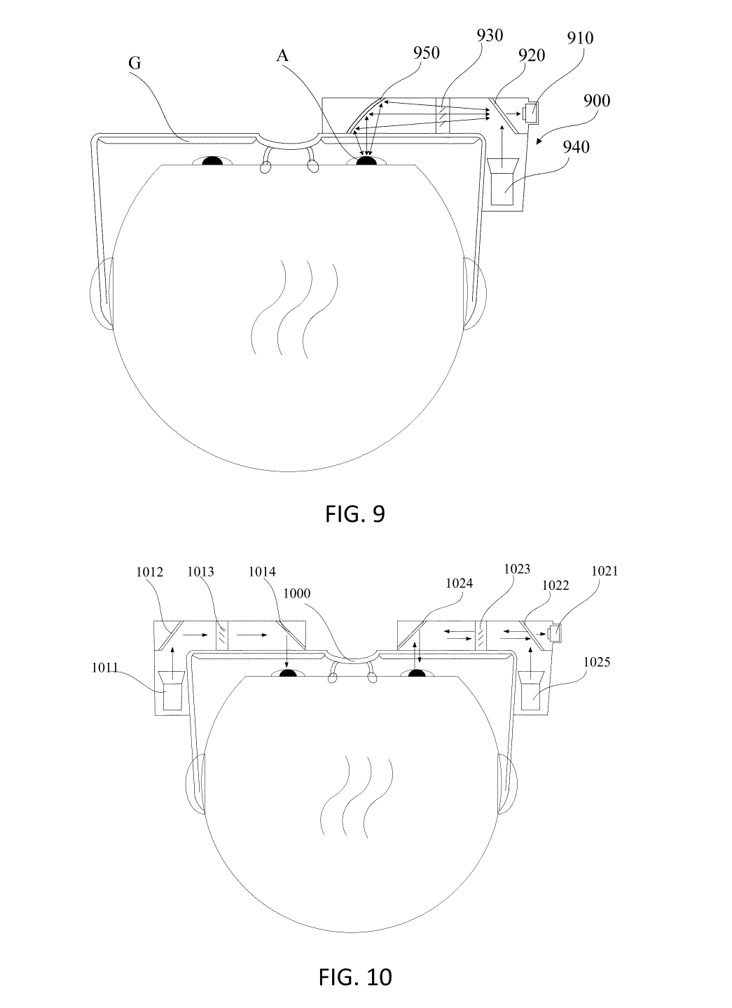

For the functions of the submodules of the projection module, reference may be made to the description of corresponding steps in the method embodiments, and an example is given in the following embodiments shown in FIG. 7a to FIG. 7d, FIG. 8 and FIG. 9.

In the embodiments of the present application, the verification prompt information is projected according to the location of the object relative to the user, so that the verification prompt information can be directly displayed at the location where the object is located and the user can view the verification prompt information while fixing on the object without adjusting the focal length of the eye. In addition, this fundus projection manner is both natural and secrete, so that the user sees the authenticity verification information about the object while viewing the object, and at the same time, other people do not see the information.

In some embodiments, the image acquired by the user in the image acquisition step may be the images of all the objects appearing in the field of view of the user, and in the embodiments of the present application, the verification process may be performed on one or some main objects to be anti-counterfeited in the field of view. However, since the user may only need to verify the object on which the user gazes, verification on all the objects in the field of view of the user causes resource waste. Therefore, in other embodiments, an object on which the user gazes may be determined first, and then the verification process is performed on the object, avoiding the verification on other unnecessary objects. As shown in FIG. 6b, in the embodiments of the present application, the apparatus 600 further includes:

a gaze object determining module 640, used for determining an object on which a user gazes.

At this moment, in this implementation manner, the apparatus 600 further includes:

a location detection module 650, used for detecting a location of a gaze point of the user relative to the user; and

the gaze object determining module 640, used for determining, according to the location of the gaze point relative to the user, the object on which the user gazes.

Here, since the user is fixing on the object at this moment, the location corresponding to the gaze point of the user is the location where the object is located. That is, a result obtained by the location detection module 650 may be used in the projection process of the information projection module 630.

Hereinafter, the structure of the location detection module is described in detail:

In the embodiments of the present application, there may be multiple implementation manners for the location detection module 650, such as the apparatus corresponding to the methods i) to iii) in the method embodiment. In the embodiments of the present application, the location detection module corresponding to the method iii) is further described with the implementation manners corresponding to FIG. 7a to FIG. 7d, FIG. 8 and FIG. 9:

As shown in FIG. 7a, in a possible implementation manner of the embodiments of the present application, the location detection module 700 includes:

a fundus image collection submodule 710, used for collecting an image of a fundus of the user;

an adjustable imaging submodule 720, used for adjusting at least one imaging parameter of an optical path between a collection location of the fundus image and an eye of the user until a clearest image is collected; and

an image processing submodule 730, used for analyzing the collected fundus image to obtain the imaging parameter, corresponding to the clearest image, of the optical path between the collection location of the fundus image and the eye and at least one optical parameter of the eye, and calculating the location of the gaze point of the user relative to the user.

This location detection module 700 obtains, by analyzing the image of the eye fundus, the optical parameter of the eye when the fundus image collection submodule obtains the clearest image and therefore can calculate the location of the current gaze point of the eye.

Here, the image presented by the “fundus” is mainly an image presented on the retina, which may be an image of the fundus itself or an image of another object projected to the fundus. Here, the eye may be a human eye or an eye of another animal.

As shown in FIG. 7b, in a possible implementation manner of the embodiments of the present application, the fundus image collection submodule 710 is a micro camera, and in another possible implementation manner of the embodiments of the present application, the fundus image collection submodule 710 may also be implemented directly using a photographic imaging element, such as a CCD or a CMOS.

In a possible implementation manner of the embodiments of the present application, the adjustable imaging submodule 720 includes: an adjustable lens element 721, located on the optical path between the eye and the fundus image collection submodule 710, and the focal length thereof is adjustable and/or the location thereof in the optical path is adjustable. The adjustable lens element 721 enables a system equivalent focal length between the eye and the fundus image collection submodule 710 to be adjustable, and the adjustment of the adjustable lens element 721 enables the fundus image collection submodule 710 to obtain a clearest image of the fundus when the adjustable lens element 721 is located at a certain location or in a certain state. In this implementation manner, the adjustable lens element 721 performs continuous and real-time adjustment during detection.

In a possible implementation manner of the embodiments of the present application, the adjustable lens element 721 may be: a focal-length adjustable lens, used for adjusting the focal length by adjusting its refraction index and/or shape. Specifically: 1) the focal length is adjusted by adjusting a curvature of at least one surface of the focal-length adjustable lens, for example, adjusting the curvature of the focal-length adjustable lens by increasing or reducing the liquid medium in a cavity formed by two transparent layers; and 2) the focal length is adjusted by changing the refraction index of the focal-length adjustable lens, for example, a specific liquid crystal medium is filled in the focal-length adjustable lens, and an arrangement manner of the liquid crystal medium by adjusting a voltage of a corresponding electrode of the liquid crystal medium, thereby changing the refraction index of the focal-length adjustable lens.

In another possible implementation manner of the embodiments of the present application, the adjustable lens element 721 includes: a lens set for adjusting the focal length of the lens set by adjusting a relative location between lenses in the lens set. The lens set may also include a lens, of which an imaging parameter, such as the focal length, is adjustable.

In addition to the two methods of changing the system optical path parameter by using the characteristics of the adjustable lens element 721 itself, the system optical path parameter may also be changed by adjusting the location of the adjustable lens element 721 on the optical path.

In a possible implementation manner of the embodiments of the present application, in order not to affect the viewing experience of the user on the observed object and in order to portably apply the system on a wearable device, the adjustable imaging submodule 720 further includes: a beam splitting unit 722, used for forming light transfer paths between the eye and the object and between the eye and the fundus image collection submodule 710. In this way, the optical path can be folded, reducing the system volume while not affecting other visual experience of the user as far as possible.

In this implementation manner, the beam splitting unit includes: a first beam splitting unit, located between the eye and the observed object, and used for transmitting light from the observed object to the eye and transferring light from the eye to the fundus image collection submodule.

The first beam splitting unit may be a beam splitter, a beam splitting optical waveguide (including an optical fiber) or another proper beam splitting device.

In a possible implementation manner of the embodiments of the present application, the image processing submodule 730 of the system includes an optical path calibration unit, used for calibrating the optical path of the system, for example, aligning and calibrating the optical axis of the optical path so as to ensure the measurement precision.

In a possible implementation manner of the embodiments of the present application, the image processing submodule 730 includes:

an image analysis unit 731, used for analyzing the image obtained by the fundus image collection submodule to find the clearest image; and

a parameter calculation unit 732, used for calculating the optical parameter of the eye according to the clearest image and the imaging parameter that is known when the clearest image is obtained.

In this implementation manner, the adjustable imaging submodule 720 enables the fundus image collection submodule 710 to obtain the clearest image, but the image analysis unit 731 is required to find the clearest image, and at this moment, the optical parameter of the eye can be obtain by calculation according to the clearest image and the system-known optical path parameter. Here, the optical parameter of the eye includes the optical axis direction of the eye.

In a possible implementation manner of the embodiments of the present application, the system may further include: a projection submodule 740, used for projecting a light spot to the fundus. In a possible implementation manner, the function of the projection submodule may be implemented with a micro projector. The functions of the projection submodule 740 and the projection submodule of the information projection module 630 may be implemented with the same device.

Here, the projected light spot may have no specific pattern and be merely used for illuminating the fundus.

In a possible implementation manner of the embodiments of the present application, the projected light spot includes a pattern with rich features. The pattern rich in features can facilitate detection and improve the detection precision. FIG. 4a is a schematic diagram of a light spot pattern P, where the pattern may be generated by a light spot generator, such as a frosted glass. FIG. 4b shows a fundus image collected when the light spot pattern P is projected.

In order not to affect the normal viewing of the eye, the light spot may be an infrared light spot invisible to the eye.

At this moment, in order to reduce the interference from other spectrum:

a light output surface of the projection submodule may be provided with an eye-invisible light transmitting filter; and

a light input surface of the fundus image collection submodule is provided with an eye-invisible light transmitting filter.

In a possible implementation manner of the embodiments of the present application, the image processing submodule 730 may further include:

a projection control unit 734, used for controlling, according to a result obtained by the image analysis unit 731, brightness of the light spot projected by the projection submodule 740.

For example, the projection control unit 734 may self-adaptively adjust the brightness according to the characteristics of the image obtained by the fundus image collection submodule 710. Here, the characteristics of the image include the contrast of image features, texture features and so on.

Here, a special case for controlling the brightness of the light spot projected by the projection submodule 740 is to turn on or turn off the projection submodule 740, for example, the projection submodule 740 may be turned off periodically when the user continuously gazes on a point; and a light-emitting source may be turned off when the fundus of the user is bright enough, and the distance from the current sight line gaze point of the eye to the eye is detected using fundus information only.

In addition, the projection control unit 734 may also control, according to ambient light, the brightness of the light spot projected by the projection submodule 740.

In a possible implementation manner of the embodiments of the present application, the image processing submodule 730 may further include: an image calibration unit 733, used for calibrating the fundus image to obtain at least one reference image corresponding to the image presented on the fundus.

The image analysis unit 731 compares and calculates the image obtained by the fundus image collection submodule 730 and the reference image to obtain the clearest image. Here, the clearest image may be an obtained image with the smallest difference from the reference image. In this implementation manner, the difference between the currently obtained image and the reference image may be calculated using an existing image processing algorithm, such as using a classic phase difference automatic focusing algorithm.

In a possible implementation manner of the embodiments of the present application, the parameter calculation unit 732 may include:

an eye optical axis direction determining subunit 7321, used for obtaining the eye optical axis direction according to the feature of the eye when the clearest image is obtained.

Here, the feature of the eye may be acquired from the clearest image or acquired elsewhere. The gaze direction of the sight line of the eye of the user may be obtained according to the optical axis direction of the eye.

In a possible implementation manner of the embodiments of the present application, the eye optical axis direction determining subunit 7321 includes: a first determining subunit, used for obtaining the eye optical axis direction according to the feature of the fundus when the clearest image is obtained. Compared with obtaining the eye optical axis direction by using the features of the pupil and the eyeball surface, the precision of determining the eye optical axis direction with the feature of the fundus is higher.

When projecting a light spot pattern to the fundus, the size of the light spot pattern may be greater than a fundus visible area or smaller than the fundus visible area.

When the area of the light spot pattern is less than or equal to the fundus visible area, the optical axis direction of the eye may be determined by detecting the location of the light spot pattern on the image relative to the fundus and using a classic feature point matching algorithm (such as SIFT);

When the area of the light spot pattern is greater than the fundus visible area, the optical axis direction of the eye and the sight line direction of the observer may be determined using the location of the obtained light spot pattern on the image relative to the original light spot pattern (obtained by the image calibration unit).

In another possible implementation manner of the embodiments of the present application, the eye optical axis direction determining subunit 7321 includes: a second determining subunit, used for obtaining an eye optical axis direction according to the feature of the eye pupil when the clearest image is obtained. Here, the feature of the eye pupil may be acquired from the clearest image or acquired elsewhere. Obtaining the optical axis direction of the eye through the eye pupil feature belongs to the prior art, which is not described here.

In a possible implementation manner of the embodiments of the present application, the image processing submodule 730 further includes: an eye optical axis direction calibration unit 735, used for calibrating the eye optical axis direction so as to determine the eye optical axis direction more precisely.

In this implementation manner, the system-known imaging parameter includes a fixed imaging parameter and a real-time imaging parameter, where the real-time imaging parameter is parameter information about the optical element when the clearest image is acquired, and the parameter information may be obtained by recording in real time when the clearest image is acquired.

Hereinafter, the distance from the eye gaze point to the eye is obtained, which is specifically as follows:

FIG. 7c is a schematic diagram of eye imaging, and with reference to a lens imaging formula in the classic optical theory, formula (1) may be obtained from FIG. 7c:

$$\frac{1}{{d}_{o}} + \frac{1}{{d}_{e}} = \frac{1}{{f}_{e}} \qquad ( 1 )$$

where dₒ and dₑ are respectively distances from a currently observed object 7010 of the eye and a real image 7020 on the retina to an eye equivalent lens 7030, fₑ is an equivalent focal length of the eye equivalent lens 7030, and X is a sight line direction of the eye (which may be obtained from the optical axis direction of the eye).

FIG. 7d is a schematic diagram of a distance from the gaze point of the eye to the eye, which is obtained according to the system-known optical parameter and the optical parameter of the eye, and in FIG. 7d, a light spot 7040 forms a virtual image by using the adjustable lens element 721 (not shown in FIG. 7d). Assuming that the distance from the virtual image to the lens is x (not shown in FIG. 7d), and the following equation set may be obtained with reference to formula (1):

$$\{ \begin{matrix}\frac{1}{{d}_{p}} - \frac{1}{x} = \frac{1}{{f}_{p}} \\ \frac{1}{{d}_{i} + x} + \frac{1}{{d}_{e}} = \frac{1}{{f}_{e}}\end{matrix} \qquad ( 2 )$$

where dₚ is an optical equivalent distance from the light spot 7040 to the adjustable lens element 721, dᵢ is an optical equivalent distance from the adjustable lens element 721 to the eye equivalent lens 7030, and fₚ is a focal length value of the adjustable lens element 721.

The distance dₒ from the currently observed object 7010 (eye gaze point) to the eye equivalent lens 7030 may be obtained from (1) and (2), as shown in formula (3):

$${d}_{o} = {d}_{i} + \frac{{d}_{p} \cdot {f}_{p}}{{f}_{p} - {d}_{p}} \qquad ( 3 )$$

According to the distance obtained by calculation from the observed object 7010 to the eye and the optical axis direction of the eye that can be obtained from the foregoing recording, and the location of the gaze point of the eye can be obtained easily, which provides a basis for further interaction related to the eye in the following.

FIG. 8 shows an embodiment where a location detection module 800 in a possible implementation manner of the embodiments of the present application is applied to a pair of spectacles G, which includes the recorded content of the implementation manner shown in FIG. 7b and is specifically: It can be seen from FIG. 8 that, in this implementation manner, the module 800 of this implementation manner is integrated at the right side of the spectacles G (not limited thereto), including:

a micro camera 810, which functions the same as the fundus image collection submodule recorded in the implementation manner of FIG. 7b, and is provided at the outer right side of the spectacles G in order to not affect the sight line when the user views an object normally;

a first beam splitter 820, which functions the same as the first beam splitting unit recorded in the implementation manner of FIG. 7b, and is provided at the intersection point of the gaze direction of the eye A and the light input direction of the camera 810 with a certain angle and used for transmitting the light of the observed object to the eye A and reflecting the light from the eye to the camera 810; and

a focal-length adjustable lens 830, which functions the same as the focal-length adjustable lens recorded in the implementation manner of FIG. 7b, and is located between the first beam splitter 820 and the camera 810 and used for adjusting the focal length value in real time, so that at a certain focal length value, the camera 810 can capture a clearest image of the fundus.

In this implementation manner, the image processing submodule is not shown in FIG. 8, which functions the same as the image processing submodule shown in FIG. 7b.

Since the brightness of the fundus is not enough in general cases, the fundus had better be illuminated. In this implementation manner, the fundus is illuminated with a light-emitting source 840. In order not to affect user experience, the light-emitting source 840 here may be an eye-invisible light-emitting source, for example, may be an infrared light-emitting source that slightly affects the eye A and is sensitive to the camera 810.

In this implementation manner, the light-emitting source 840 is located at the outer side of the spectacle frame at the right side, and therefore, a second beam splitter 850 is required to transfer, with the first beam splitter 820, the light emitted from the light-emitting source 840 to the fundus. In this implementation manner, the second beam splitter 850 is located before the light input surface of the camera 810, and therefore, it is further required to transmit the light from the fundus to the second beam splitter 850.

It can be seen that in this implementation manner, in order to improve user experience and improve the collection definition of the camera 810, the first beam splitter 820 may have characteristics of being highly refractive to infrared light and being highly transmissive to visible light. For example, an infrared reflection film may be provided at one side of the first beam splitter 820 toward the eye A to implement the characteristics.

It can be seen from FIG. 8 that since in this implementation manner, the location detection module 800 is located at one side of the lens of the spectacles G away from the eye A, when the optical parameter of the eye is calculated, the lens may also be viewed as a part of the eye A, and at this moment, there is no need to know the optical characteristics of the lens.

In another implementation manner of the embodiments of the present application, the location detection module 800 may be located at one side of the lens of the spectacles G close to the eye A, and at this moment, it is required to pre-obtain the optical characteristics parameter of the lens and consider an affecting factor of the lens when the distance to the gaze point is calculated.

In this embodiment, the light emitted from the light-emitting source 840 is reflected by the second beam splitter 850, projected by the focal-length adjustable lens 830 and reflected by the first beam splitter 820, and then is transmitted through the lens of the spectacles G to the eye of the user, and finally arrives at the retina of the fundus; and the camera 810 captures an image of the fundus through the pupil of the eye A via an optical path formed by the first beam splitter 820, the focal-length adjustable lens 830 and the second beam splitter 850.

In a possible implementation manner, other parts of the anti-counterfeiting apparatus in the embodiments of the present application are also implemented on the spectacles G, and since both the location detection module and the information projection module may include: a device with a projection function (such as the projection submodule of the information projection module and the projection submodule of the location detection module that are mentioned above); and an imaging device with an adjustable imaging parameter (such as the parameter adjustment submodule of the information projection module and the adjustable imaging submodule of the location detection module that are mentioned above) and so on, in a possible implementation manner of the embodiments of the present application, the functions of the location detection module and the projection module are implemented by the same device.

As shown in FIG. 8, in a possible implementation manner of the embodiments of the present application, the light-emitting source 840 may be used as a light source of the projection submodule of the information projection submodule to assist projecting the verification prompt information, in addition to being used for illuminating the location detection module. In a possible implementation manner, the light-emitting source 840 can simultaneously project invisible light to illuminate the location detection module; and visible light to assist projecting the verification prompt information. In another possible implementation manner, the light-emitting source 840 may be switched between projecting the invisible light and projecting visible light in a time division manner. In still another possible implementation manner, the location detection module may use the verification prompt information to implement the function of illuminating the fundus.

In a possible implementation manner of the embodiments of the present application, the first beam splitter 820, the second beam splitter 850 and the focal-length adjustable lens 830 may also be used as the adjustable imaging submodule of the location detection module in addition to being used as the parameter adjustment submodule of the information projection module. Here, in a possible implementation manner, the focal length of the focal-length adjustable lens 830 may be adjusted according to areas, and different areas correspond to the location detection module and the projection module respectively, and the focal length may be different as well. Alternatively, the focal length of the focal-length adjustable lens 830 is adjusted as a whole, but the front end of the photosensitive unit (such as a CCD) of the micro camera 810 of the location detection module is further provided with other optics for implementing the auxiliary adjustment of the imaging parameter of the location detection module. In addition, in another possible implementation manner, the optical length from the light output surface (that is, the projection location of the verification prompt information) of the light-emitting source 840 to the eye may be configured to be the same as the optical length from the eye to the micro camera 810, so that when the focal-length adjustable lens 830 is adjusted to the point where the micro camera 810 receives a clearest image, the verification prompt information projected by the light-emitting source 840 is exactly imaged on the fundus clearly.

It can be seen from the above that the functions of the location detection module and the information projection module of the anti-counterfeiting apparatus in the embodiments of the present application may be implemented by one set of device, which makes the entire system simple in structure, small in volume and convenient to carry.

FIG. 9 shows a schematic structural diagram of a location detection module 900 of another implementation manner in the embodiments of the present application. It can be seen from FIG. 9 that this implementation manner is similar to the implementation manner shown in FIG. 8, including a micro camera 910, a second beam splitter 920 and a focal-length adjustable lens 930, and the difference lies in that a projection submodule 940 in this implementation manner is a projection submodule 940 for projecting a light spot pattern, and the first beam splitter in the implementation manner of FIG. 8 is replaced with a curved beam splitter 950 as the curved beam splitting element.

Here, the image presented on the fundus is transferred to the fundus image collection submodule by employing the locations of the pupil when the optical axis direction of the eye respectively corresponding to the curved beam splitter 950 is different. In this way, the camera can capture an image mixed and superposed from various angles of the eyeball. However, since the image can be formed clearly on the camera through the fundus part of the pupil only, other parts are de-focused and therefore cannot be imaged clearly, the imaging of the fundus part is not interfered severely, and the feature of the fundus part can still be detected. Therefore, compared with the implementation manner shown in FIG. 8, in this implementation manner, the image of the fundus can also be obtained when the gaze direction of the eye is different, so that the location detection module in this implementation manner can be widely applied, and the detection precision is higher.

In a possible implementation manner of the embodiments of the present application, other parts of the anti-counterfeiting apparatus in the embodiments of the present application are also implemented on the spectacles G. In this implementation manner, the location detection module and the information projection module may also be multiplexed. Similar to the embodiment shown in FIG. 8, at this moment, the projection submodule 940 can project the light spot pattern and the verification prompt information simultaneously or in a time division manner; or, the location detection module detects the projected verification prompt information as the light spot pattern. Similar to the embodiment shown in FIG. 8, in a possible implementation manner of the embodiments of the present application, the first beam splitter 920, the second beam splitter 950 and the focal-length adjustable lens 930 may also be used as the adjustable imaging submodule of the location detection module in addition to being used as the parameter adjustment submodule of the information projection module.

At this moment, the second beam splitter 950 is further used for transferring the optical path between the information projection module and the fundus by way of respectively corresponding to the locations of the pupil when the optical axis direction of the eye is different. Since the verification prompt information projected by the projection submodule 940 is deformed after passing through the curved second beam splitter 950, in this implementation manner, the projection module includes:

a reverse deforming processing module (not shown in FIG. 9), used for performing, on the verification prompt information, reverse deforming processing corresponding to the curved beam splitting element, so that the fundus receives the verification prompt information to be presented.

In an implementation manner, the projection module is used for projecting the verification prompt information to the fundus of the user in a three-dimensional manner.

The verification prompt information includes three-dimensional information respectively corresponding to the two eyes of the user, and the projection module projects corresponding verification prompt information to the two eyes of the user respectively.

As shown in FIG. 10, in a case in which three-dimensional display is required, the anti-counterfeiting apparatus 1000 needs to be provided with two sets of projection modules respectively corresponding to the two eyes of the user, including:

a first information projection module corresponding to the left eye of the user; and

a second information projection module corresponding to the right eye of the user.

The structure of the second information projection module is similar to the structure multiplexed with a location detection module function recorded in the embodiment of FIG. 10, which is also a structure that can implement both the location detection module function and a projection module function, including a micro camera 1021, a second beam splitter 1022, a second focal-length adjustable lens 1023, a first beam splitter 1024 with the same functions as those in the embodiment shown in FIG. 10 (where the image processing submodule of the location detection module is not shown in FIG. 10), and the difference lies in that the projection submodule in this implementation manner is a second projection submodule 1025 that can project the verification prompt information corresponding to the right eye. It can also be used for detecting a location of a gaze point of an eye of the user and projecting the verification prompt information corresponding to the right eye to a fundus of the right eye clearly.

The structure of the first information projection module is similar to that of the second information projection module 1020, but it does not have a micro camera and is not multiplexed with the location detection module function. As shown in FIG. 10, the first information projection module includes:

a first projection submodule 1011, used for projecting the verification prompt information corresponding to the left eye to the fundus of the left eye;

a first focal-length adjustable lens 1013, used for adjusting the imaging parameter between the first projection submodule 1011 and the fundus, so that the corresponding verification prompt information can be presented on the fundus of the left eye clearly and the user can view the verification prompt information presented on the image;

a third optical splitter 1012, used for transferring an optical path between the first projection submodule 1011 and the first focal-length adjustable lens 1013; and

a fourth optical splitter 1014, used for transferring an optical path between the first focal-length adjustable lens 1013 and the fundus of the left eye.

By means of this embodiment, the verification prompt information viewed by the user has a proper three-dimensional display effect, bringing better user experience.

In addition, the embodiments of the present application further provide a computer readable medium, including a computer executable instruction for performing the following operations when being executed: performing the operations of steps S110, S120 and S130 in the method embodiments.

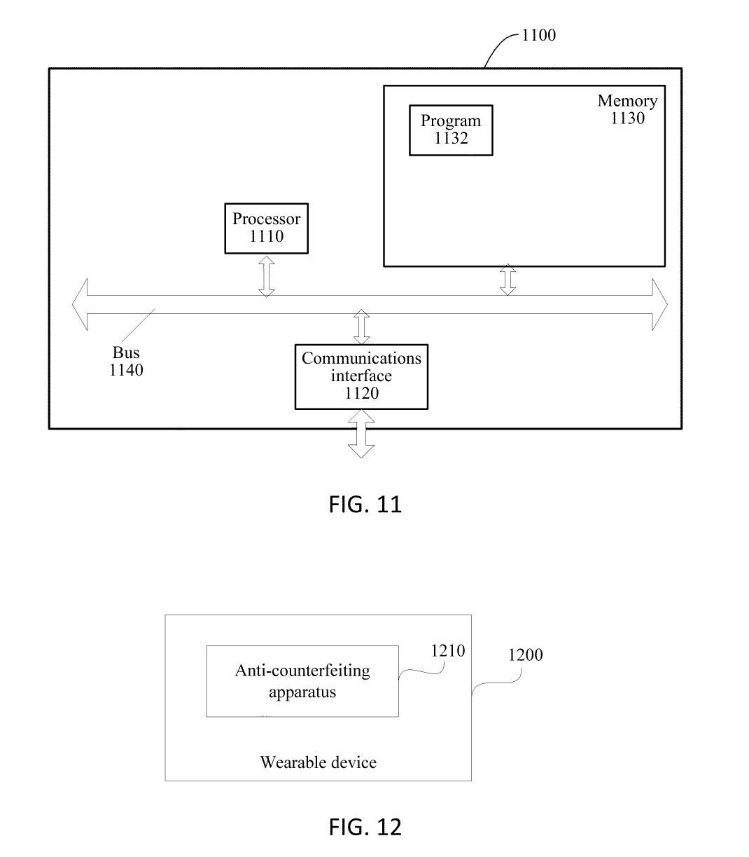

FIG. 11 is a schematic structural diagram of another anti-counterfeiting apparatus 1100 provided in the embodiments of the present application, and a specific embodiment of the present application does not limit the specific implementation of the anti-counterfeiting apparatus 1100. As shown in FIG. 11, this anti-counterfeiting apparatus 1100 may include:

a processor 1110, a communications interface 1120, a memory 1130 and a communications bus 1140.

The processor 1110, the communications interface 1120 and the memory 1130 communicate with each other through the communications bus 1140.

The communications interface 1120 is used for communicating with a network element such as a client.

The processor 1110 is used for executing a program 1132 and may specifically perform relevant steps in the method embodiments.

Specifically, the program 1132 may include program code, and the program code includes a computer operation instruction.

The processor 1110 may be a central processing unit CPU or an application specific integrated circuit, or one or more integrated circuits configured to implement the embodiments of the present application.

The memory 1130 is used for storing the program 1132. The memory 1130 may contain a high speed RAM memory, and may also include a non-volatile memory, such as at least one magnetic disk memory. The program 1132 may be specifically used for enabling the anti-counterfeiting apparatus 1110 to perform the following steps:

acquiring at least one image of an object on which a user gazes;

verifying authenticity of the object according to the at least one image to obtain verification prompt information; and

projecting the verification prompt information to a fundus of the user according to a location of the object relative to the user.

For specific implementation of the steps in the program 1132, reference may be made to the corresponding description of corresponding steps and units in the foregoing embodiments, which is not described here. A person skilled in the art may clearly understand that, for the convenience and brevity of description, for the specific working processes of the devices and modules described above, reference may be made to the corresponding process description in the method embodiments, which are not described here.

As shown in FIG. 12, the embodiments of the present application further provide a wearable device 1200, containing an anti-counterfeiting apparatus 1210 recorded in the foregoing embodiment.

The wearable device may be a pair of spectacles. In some implementation manners, the pair of spectacles may be of the structure shown in FIG. 8 to FIG. 10.

A person of ordinary skill in the art may appreciate that, in combination with various examples described in the embodiments disclosed here, the units and method steps may be implemented with electronic hardware or a combination of computer software and electronic hardware. Whether these functions are implemented by hardware or software depends on the specific application and design restrain conditions of the technical solutions. A person skilled in the art may use different methods to implement the described functions for each specific application, but this implementation shall not be deemed to go beyond the scope of the present application.

If the functions are implemented in the form of a software functional unit and sold or used as an independent product, the product may be stored in a computer readable storage medium. Based on such an understanding, the technical solutions of the present application essentially, or the part thereof contributing to the prior art, or a part of the technical solutions may be implemented in a form of a software product. The computer software product is stored in a storage medium, including several instructions for instructing a computer device (which may be a personal computer, a server, or a network device and so on) to perform all or a part of the steps of the methods in the embodiments of the present application. The storage medium includes: any medium that can store program code, such as a USB flash disk, a removable hard disk, a read-only memory (ROM), a random access memory (RAM), a magnetic disk or an optical disc.

The implementation manner is merely used for describing the present application rather than limiting the present application, and a person of ordinary skill in the art may make various modifications and variations without departing from the spirit and scope of the present application. Therefore, all the equivalent technical solutions also belong to the scope of the present application, and the scope of patent protection of the present application shall be subject to the claims.

1. A method, comprising:
acquiring, by a system comprising a processor, at least one image of an object on which a user gazes;
verifying an authenticity of the object according to the at least one image to obtain verification prompt information; and
initiating projecting the verification prompt information to a fundus of the user according to a location of the object relative to the user.

2. The method according to claim 1, wherein the initiating the projecting of the verification prompt information to the fundus of the user according to the location of the object relative to the user comprises:
adjusting at least one projection imaging parameter of an optical path between a projection location of the verification prompt information and an eye of the user, until the verification prompt information is imaged to the fundus of the user by way of corresponding to the object and satisfying at least one defined clarity criterion.

3. The method according to claim 1, wherein the verification prompt information comprises at least one piece of identification information, and the at least one piece of identification information corresponds to at least one image area in the at least one image that does not satisfy at least one verification requirement.

4. The method according to claim 3, wherein the initiating the projecting of the verification prompt information to the fundus of the user according to the location of the object relative to the user comprises:
initiating projecting the at least one piece of identification information to the fundus of the user by way of corresponding to another location which corresponds to the at least one image area on the object.

5. (canceled)

6. The method according to claim 1, wherein the verifying the authenticity of the object according to the at least one image to obtain the verification prompt information comprises:
acquiring, according to the at least one image, at least one feature to be verified corresponding to at least one predetermined anti-counterfeiting feature; and
determining whether the at least one feature to be verified comprises at least one piece of anti-counterfeiting information to be verified.

7. The method according to claim 6, wherein, in response to the at least one feature to be verified being determined to comprise the at least one piece of anti-counterfeiting information to be verified, the verifying the authenticity of the object according to the at least one image to obtain verification prompt information further comprises:
acquiring the at least one piece of anti-counterfeiting information to be verified from the at least one feature to be verified; and
verifying whether the at least one piece of anti-counterfeiting information to be verified satisfies at least one predetermined anti-counterfeiting verification protocol to obtain the verification prompt information.

8. The method according to claim 6, wherein, in response to the at least one feature to be verified being determined not to comprise the at least one piece of anti-counterfeiting information to be verified, the verifying the authenticity of the object according to the at least one image to obtain the verification prompt information further comprises:
obtaining the verification prompt information that the object is fake.

9.-11. (canceled)

12. The method according to claim 1, wherein the verifying the authenticity of the object according to the at least one image to obtain the verification prompt information comprises:
acquiring, according to the at least one image, at least one feature to be verified corresponding to at least one predetermined anti-counterfeiting feature;
sending the at least one feature to be verified to an external device; and
receiving the verification prompt information returned from the external device.

13. (canceled)

14. The method according to claim 1, wherein the verifying the authenticity of the object according to the at least one image to obtain the verification prompt information comprises:
verifying whether the at least one image comprises at least one predetermined anti-counterfeiting feature to obtain the verification prompt information.

15. The method according to claim 14, wherein the verifying whether the image comprises the at least one predetermined anti-counterfeiting feature to obtain the verification prompt information comprises:
acquiring, according to the at least one image, at least one feature to be verified corresponding to the at least one predetermined anti-counterfeiting feature; and
verifying whether the at least one feature to be verified satisfies at least one predetermined verification standard to obtain the verification prompt information.

16. The method according to claim 15, wherein the at least one feature to be verified comprises at least one of at least one image feature corresponding to at least one location or at least one pattern of the at least one predetermined anti-counterfeiting feature.

17. (canceled)

18. The method according to claim 1, wherein the object comprises image information displayed by an electronic device.

19. The method according to claim 1, further comprising:
determining the object on which the user gazes.

20. The method according to claim 19, further comprising:
detecting another location of a gaze point of the user relative to the user,
wherein the determining the object on which the user gazes comprises:
determining, according to the other location of the gaze point of the user relative to the user, the object on which the user gazes.

21. An apparatus, comprising:
a processor that executes executable modules to perform operations of the device, the executable modules comprising:
an image acquisition module configured to acquire at least one image of an object on which a user gazes;
an authenticity verification module configured to verify an authenticity of the object according to the at least one image to obtain verification prompt information; and
an information projection module configured to project the verification prompt information to a fundus of the user according to a location of the object relative to the user.

22. The apparatus according to claim 21, wherein the information projection module comprises:
a projection submodule configured to project the verification prompt information; and
a parameter adjustment submodule configured to adjust at least one projection imaging parameter of an optical path between a projection location of the verification prompt information and an eye of the user, until the verification prompt information is imaged to the fundus of the user by way of corresponding to the object and satisfying at least one defined clarity criterion.

23. The apparatus according to claim 21, wherein the verification prompt information comprises at least one piece of identification information, and the at least one piece of identification information corresponds to at least one image area in the at least one image that does not satisfy at least one verification requirement; and
wherein the information projection module is further configured to project the at least one piece of identification information to the fundus of the user by way of corresponding to at least one location that corresponds to the at least one image area on the object.

24. (canceled)

25. The apparatus according to claim 21, wherein the authenticity verification module comprises:
a feature acquisition submodule configured to acquire, according to the at least one image, at least one feature to be verified corresponding to the at least one predetermined anti-counterfeiting feature; and
an information determining submodule configured to determine whether the at least one feature to be verified comprises at least one piece of anti-counterfeiting information to be verified.

26. The apparatus according to claim 25, wherein the authenticity verification module further comprises:
an anti-counterfeiting information acquisition submodule configured to, in response to the at least one feature to be verified being determined to comprise the at least one piece of anti-counterfeiting information to be verified, acquire the at least one piece of anti-counterfeiting information to be verified; and
an anti-counterfeiting information verification submodule configured to verify whether the at least one piece of anti-counterfeiting information to be verified satisfies at least one predetermined anti-counterfeiting verification standard to obtain the verification prompt information.

27. The apparatus according to claim 25, wherein, the information determining submodule is further configured to, in response to the at least one feature to be verified being determined not to comprise the at least one piece of anti-counterfeiting information to be verified, obtain the verification prompt information that the object is fake.

28.-32. (canceled)

33. The apparatus according to claim 21, wherein the authenticity verification module is further configured to verify whether the at least one image comprises at least one predetermined anti-counterfeiting feature to obtain the verification prompt information.

34. The apparatus according to claim 21, wherein the authenticity verification module comprises:
a first communications submodule configured to:
send the at least one image to the external device; and
receive the verification prompt information returned from the external device.

35. The apparatus according to claim 33, wherein the authenticity verification module further comprises:
a feature acquisition submodule configured to acquire, according to the at least one image, at least one feature to be verified corresponding to the at least one predetermined anti-counterfeiting feature; and
a feature verification submodule configured to verify whether the at least one feature to be verified satisfies at least one predetermined verification standard to obtain the verification prompt information.

36. The apparatus according to claim 35, wherein the feature acquisition submodule is further configured to:
acquire, according to the at least one image, at least one image feature corresponding to at least one location or at least one pattern of the at least one predetermined anti-counterfeiting feature as the at least one feature to be verified.

37. The apparatus according to claim 21, wherein the executable modules further comprise:
a gaze object determining module configured to determine the object on which the user gazes.

38. The apparatus according to claim 37, wherein the executable modules further comprise:
a location detection module configured to detect another location of a gaze point of the user relative to the user, wherein the gaze object determining module is further configured to determine, according to the other location of the gaze point relative to the user, the object on which the user gazes.

39. (canceled)

40. A computer readable storage device, comprising at least one executable instruction, which, in response to execution, causes a system comprising a processor to perform operations, comprising:
acquiring at least one image of an object on which a user gazes;
verifying an authenticity of the object according to the at least one image to obtain verification prompt information; and
projecting the verification prompt information to a fundus of the user according to a location of the object relative to the user.

41. An anti-counterfeiting apparatus, comprising a processor and a memory, wherein the memory stores an executable instruction, wherein the processor and the memory are communicatively coupled, and when the anti-counterfeiting apparatus operates, the processor executes the executable instruction stored in the memory to cause the anti-counterfeiting apparatus to perform operations, comprising:
acquiring an image of an object on which a user gazes;
verifying an authenticity of the object according to the image to obtain verification prompt information; and
initiating projecting the verification prompt information to a fundus of the user according to a location of the object relative to the user.
